(19) United States
(12) Patent Application Publication
(10) Pub. No.: US 2023/0368603 A1
(43) Pub. Date: Nov. 16, 2023

(54) GAMING MACHINE

(71) Applicant: SAMMY CORPORATION, Shinagawa-ku (JP)

(72) Inventors: Takaya YONEDA, Shinagawa-ku (JP); Jun NISHIOKA, Shinagawa-ku (JP); Yusuke HASHIMOTO, Shinagawa-ku (JP); Hiroyuki ITO, Shinagawa-ku (JP); Kazuaki UTSUNOMIYA, Shinagawa-ku (JP); Teppei HIGASHI, Shinagawa-ku (JP); Shinya OHTANI, Shinagawa-ku (JP); Taiji SUGAI, Shinagawa-ku (JP)

(73) Assignee: SAMMY CORPORATION, Shinagawa-ku (JP)

(21) Appl. No.: 18/246,785

(22) PCT Filed: Sep. 29, 2020
(86) PCT No.: PCT/JP2020/036974

§ 371 Date: Mar. 27, 2023

(51) Int. Cl. G07F 17/32

(52) U.S. Cl. CPC G07F 17/3213; G07F 17/3267; G07F 17/323

(57) ABSTRACT

The present invention provides a gaming machine that can maintain a sense of expectation of a player and continue a game. The gaming machine includes a display including a scroll area where a video reel including a plurality of main symbols is scrolled, the main symbols are rearranged after the scrolling, and a game result of a unit game is displayed and a non-scroll area where the video reel is not scrolled, a sub-symbol different from the main symbols being displayed in the non-scroll area and moving from the non-scroll area to the scroll area, a memory that stores information concerning the main symbols and information concerning the sub-symbol, and a controller that controls display of the main symbols and the sub-symbol on the display, the controller determining display content of the sub-symbol based on at least one probability mode among a plurality of probability modes respectively associated with probabilities different from one another.

### TECHNICAL FIELD

The present invention relates to a gaming machine that can grant various prizes in, for example, a base game such as a video slot game.

### BACKGROUND ART

There has been known a gaming machine in which, besides a base game, a feature game such as a roulette game is executed (see, for example, Patent Literature 1.).

### CITATION LIST

### Patent Literature

Patent Literature 1: US2016/0093145 A

### SUMMARY OF INVENTION

### Technical Problem

In the gaming machine of the related art, a player cannot recognize even prizes likely to be granted halfway in a game and can recognize only pries actually granted according to a result of the game. For this reason, the player cannot predict development of the game at all. It is difficult to increase the player's expectation.

The present invention has been made in view of the above points, and an object of the present invention is to provide a gaming machine that can maintain player's expectation and continuously advancing a game by suggesting beforehand a prize likely to be granted to the player.

### Solution to Problem

A characteristic of a gaming machine according to the present invention is that the gaming machine includes:
a display including a scroll area where a video reel including a plurality of main symbols is scrolled, the main symbols are rearranged after the scrolling, and a game result of a unit game is displayed and a non-scroll area where the video reel is not scrolled, a sub-symbol different from the main symbols being displayed in the non-scroll area and moving from the non-scroll area to the scroll area;
a memory that stores information concerning the main symbols and information concerning the sub-symbol; and
a controller that controls display of the main symbols and the sub-symbol on the display, the controller determining display content of the sub-symbol based on at least one probability mode among a plurality of probability modes respectively associated with probabilities different from one another.

### Advantageous Effects of Invention

It is possible to maintain the player's expectation and continuously advance a game.

### BRIEF DESCRIPTION OF DRAWINGS

FIG. 1 is a front view illustrating an exterior of a gaming machine 10 according to an embodiment.

FIG. 2 is a block diagram illustrating a main hardware configuration of the gaming machine 10.

FIG. 3 is a diagram illustrating a plurality of gaming machines 10 connected to a network.

FIG. 4 is a diagram illustrating a configuration of a display region of a display 210.

FIG. 5 is a flowchart illustrating game processing.

FIG. 6 is a flowchart illustrating symbol lottery processing.

FIG. 7 is a flowchart illustrating mode determination processing.

FIG. 8 is a flowchart illustrating symbol lottery processing.

FIG. 9 is a flowchart illustrating fish group display processing.

FIG. 10 is a flowchart illustrating fish group display processing.

FIG. 11 is a flowchart illustrating scroll display control processing.

FIG. 12 is a table defining a correspondence relation between an array of symbols of one reel and weights allocated to the symbols.

FIG. 13 is a management table for managing types of bubbles and modes of the bubbles in a state before the bubbles are displayed in a symbol display region 400.

FIG. 14 is a management table for managing types of bubbles and modes of the bubbles in a state before the bubbles are displayed in the symbol display region 400.

FIG. 15 is a symbol display region management table for managing types of bubbles and modes of the bubbles displayed in the symbol display region 400.

FIG. 16 is a table illustrating four mode lottery tables defining a relation between modes and allocation ranges.

FIG. 17 is a diagram illustrating an example of movement of bubbles.

FIG. 18 is a diagram illustrating an example of movement of bubbles.

FIG. 19 is a diagram illustrating forms of bubbles displayed in the symbol display region 400 according to types of the bubbles.

FIG. 20 is a diagram illustrating bubbles that arrive at an arrival display region 434.

FIG. 21 is a diagram illustrating precursor display and fish group display.

FIG. 22 is a diagram illustrating a form of bubbles displayed in a free game.

### DESCRIPTION OF EMBODIMENTS

### Overview of Embodiments

### First Aspect

According to a first aspect, there is provided a gaming machine including:
a display (for example, a main display 210 explained below) including: a scroll area (for example, a symbol display region 400 explained below) where a video reel including a plurality of main symbols (for example, symbols explained below) is scrolled, the main symbols are rearranged after the scrolling, and a game result of a unit game is displayed and a non-scroll area (for example, a non-scroll area 430 and a pre-display region 432 explained below) where the video reel is not scrolled, a sub-symbol (for example, bubbles explained below) different from the main symbols being displayed in the non-scroll area and moving from the non-scroll area to the scroll area;
a memory (for example, a RAM 130 explained below) that stores information concerning the main symbols and information concerning the sub-symbol; and
a controller (for example, a CPU 110 explained below) that controls display of the main symbols and the sub-symbol on the display, the controller determining display content of the sub-symbol based on at least one probability mode among a plurality of probability modes (for example, modes A to E explained below) respectively associated with probabilities different from one another.

The gaming machine includes the display, the memory, and the controller.

The main symbols and the sub-symbol are displayed on the display. The main symbols are rearranged in the scroll area to display the game result of the unit game. The sub-symbol is moved from the non-scroll area to the scroll area and displayed. The sub-symbol is associated with a prize likely to be granted. The display of the sub-symbol allows the player to predict the prize likely to be granted.

The gaming machine has the plurality of probability modes respectively associated with the probabilities different from one another. One prize is selected from the plurality of prizes according to a probability corresponding to a probability mode. The prize is, for example, granting a payout, transition to the bonus game, and the like.

The controller determines the display content of the sub-symbol based on at least one probability mode among the plurality of probability modes. The plurality of probability modes respectively correspond to the probabilities different from one another. The probability is a ratio for determining display content of the sub-symbol. The memory stores probabilities corresponding to the respective plurality of probability modes.

The display content of the sub-symbol is determined according to the probability corresponding to the probability mode. It is preferable that there are a plurality of types of display contents of the sub-symbol. For example, in a certain probability mode, first display content can be easily determined and second display content can be less easily determined and, in another probability mode, the first display content can be less easily determined and the second display content can be easily determined. By designating a probability mode, it is possible to control, with a probability, display content that is easily determined and display content that is less easily determined.

The display content of the sub-symbol may be configured by characters or may be configured by figures. The display content of the sub-symbol only has to be information that can be visually recognized by the player.

When the sub-symbol is displayed in the non-scroll area, it is possible to cause the player to expect a progress of the game in the future with display content of the sub-symbol. When the sub-symbol is displayed in the scroll area, since the sub-symbol is displayed together with the main symbols, it is possible to cause the player to expect possibility of changing the game result.

Further, in the first aspect,
the controller can execute probability mode determination processing for determining a series of probability modes with a probability mode sequentially selected from the plurality of probability modes, the next probability mode being selected based on an already selected probability mode in the probability mode determination processing.

Note that the controller executes potential prize selection processing for selecting one potential prize from a plurality of potential prizes, the one potential prize being selected according to a probability associated with one probability mode included in the series of probability modes, and
the sub-symbol can be associated with the potential prize.

The potential prize is not a prize that is definitely granted and means a prize that is likely to be granted to the player. When a predetermined condition is satisfied in a relation with the main symbols, the potential prize changes from the potential prize and the definite prize and is granted to the player.

The controller preferably selects one probability mode from the plurality of probability modes. One probability mode is preferably selected based on an already selected probability mode. For example, the controller selects one probability mode referring to a probability mode selected immediately before the one probability mode. The controller may select one probability mode referring to not only the probability mode selected immediately before the one probability mode but also at least one probability mode among probability modes selected in the past.

The selected probability modes are sequentially arranged to generate a series of probability modes. For example, a series of probability modes can be generated by arranging a selected plurality of probability modes in order of the selection. In other words, a series of probability modes can be generated by selecting and arranging probability modes in a chain manner. By generating the series of probability modes, it is possible to determine transition of probabilities (a flow of changes in probabilities) for selecting potential prizes and form the transition as a scenario of potential prizes to be suggested to the player. That is, instead of determining potential prizes at random, it is possible to form the flow of the potential prizes with the scenario.

By displaying the sub-symbol indicating the potential prizes selected according to the scenario, it is possible to cause the player to continue the game while gradually increasing the player's expectation.

The prizes include a first prize determined only by the main symbols and a second prize determined by the main symbols and the sub-symbol. For the first prize, a winning combination is determined only by the main symbols stopped and displayed. For the second prize, a winning combination is determined by the main symbols and the sub-symbol which stopped and displayed. For example, the main symbols stopped and displayed and the sub-symbol stopped and displayed overlap and the winning combination is determined by the two symbols in an overlapping state. That is, the second prize is a prize decided by the main symbols stopped and displayed and the sub-symbol indicating the potential prize being displayed to overlap.

### Second Aspect

According to a second aspect is, in the first aspect,
the controller is capable of executing a base game and a bonus game different from the base game,
prizes include provision of a payout and provision of the bonus game, and
the memory includes:
a first table for lottery that determines a first sub-symbol indicating that the payout can be provided; and
a second table for lottery that determines a second sub-symbol indicating that the bonus game can be provided, the second table for lottery being selected at a probability higher than a probability that the first table for lottery is selected, and
prize selection processing selects the one prize referring to the first table for lottery and the second table for lottery.

### Third Aspect

According to a third aspect, in the first aspect,
one or more unit games are associated as a single set, and one probability mode included in the series of probability modes is used for one set.

One unit game may be set as a single set (a single unit or block) or a plurality of unit games, for example, five unit games may be set as a single set (a single unit or block). With a correspondence between the number of unit games and the number of sets, it is possible to make the transition of the probability steep or gentle and it is possible to provide speed fluctuation in the change in the prizes (the flow of the scenario).

### Fourth Aspect

According to a fourth aspect, in the third aspect,
the series of probability modes are determined in advance for each of a plurality of sets.

It is possible to maintain player's expectation for a future unit game by determining beforehand prizes likely to be given in the future unit game and displaying in advance the sub-symbol corresponding to the prizes.

### Fifth Aspect

According to a fifth aspect, in the fourth aspect,
when a specific probability mode is included in the series of probability modes, the controller displays, on the display, information indicating that the specific probability mode is included.

It is possible to notify the player beforehand that the specific probability mode is included and it is possible to maintain the player's expectation for a future unit game while increasing the player's expectation.

### Sixth Aspect

According to a sixth aspect, in the fifth aspect,
when the controller is capable of communicating with other gaming machines via a network and the specific probability mode is included in the plurality of sets, the controller transmits information indicating that the gaming machine has the specific probability mode to the other gaming machines.

Since the specific probability mode can be notified even to the other gaming machines, it is possible to cause the player to expect that the specific prize is generated in the player's own gaming machine.

### Seventh Aspect

According to a seventh aspect, in the sixth aspect,
when a specific prize is selected and the player maintains the same bet and continues a game, the controller makes it possible to provide the specific prize after information indicating that the specific probability mode is included is displayed on the display, and
when the specific prize is selected and the player ends the game or changes the bet and advances the game, the controller does not provide the specific prize after the information indicating that the specific probability mode is included is displayed on the display.

It is possible to prevent not only the player himself or herself but also other players from becoming unreasonably advantageous.

### Details of the Present Embodiment

### Explanation of Terms

### <Scrolling (Spinning)>

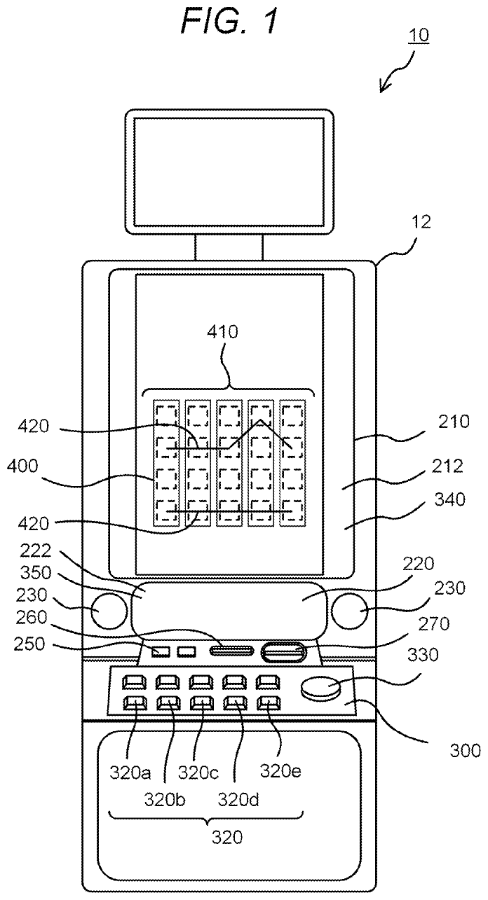

Scrolling means display by moving video reels 410a to 410e (see FIG. 1) in a symbol display region 400. By scrolling a video reel 410, a symbol allocated to the video reel 410 is also displayed to move in the symbol display region 400. In general, the scrolling is performed up to down in principle. However, the scrolling may be performed down to up, the right to the left, or the left to the right according to a type of a game, rendering, or the like. Note that spinning is synonymous with the scrolling.

### <Re-Scrolling (Re-Spinning)>

Re-scrolling is processing for once stopping the scrolled video reels 410a to 410e in the symbol display region 400 and thereafter scrolling the video reels 410a to 410e again in one unit game. Note that it is unnecessary to re-scroll all the video reels 410a to 410e. Any one video reel 410 can be selectively re-scrolled according to a result of symbol lottery processing or the like. Note that re-spinning is synonymous with the re-scrolling.

### <Stop-Display>

Stop-display means processing for displaying a symbol, in a stopped state, in each of stop positions in the symbol display region 400 when the video reels 410a to 410e are stopped.

### <Rearrangement>

Rearrangement means stopping the video reels 410a to 410e and stop-displaying a symbol in the symbol display region 400. The rearrangement is a state in which arrangement of the symbols is once released by scrolling the video reels 410a to 410e and thereafter the symbol is arranged again.

### <Unit Game>

In the video slot game, a period from when subtraction processing for the number of owned credits is executed until when the video reels 410a to 410e are stopped and dispensing processing is ended is referred to as unit game. The subtraction processing for the number of owned credits is internal processing and is different from BET operation by the player. When a BET button 320 is operated (BET operation), the number of BETs (a BET ratio) is stored in a RAM 130. In a state in which the number of BETs (the BET ratio) is stored in the RAM 130, the video slot game can be started only by operation of a SPIN button 330. Note that the unit game may be set not from the subtraction processing for the number of owned credits but from the scrolling of the video reels 410a to 410e is started until the video reels 410a to 410e are stopped and the dispensing processing is ended.

### <Winning Combination>

The winning combination refers to a sequence of symbols to which prizes are granted. When the sequence of symbols stopped and displayed along a pay line 420 in the symbol display region 400 becomes the winning combination, the symbols are set as targets to which prizes are granted. In the case of scatter symbols, when the number of scatter symbols stopped and displayed is a predetermined number and the scatter symbols are set as targets to which prizes are granted, the scatter symbols are the winning combination. Here, the granting of the prizes is not limited to only provision (dispensing) of a payout and only has to be directly or indirectly advantageous to the player such as transition to an advantageous game. The prizes are explained below.

### <Scatter Symbol>

The scatter symbol is a symbol for which establishment of the winning combination is determined according to the number of stop-displayed symbols. The scatter symbol is determined according to the number of stop-displayed symbols irrespective of whether the symbols are arranged along the valid pay line 420.

### <WILD Symbol>

A WILD symbol is a symbol that can be substituted for another symbol stop-displayed in the symbol display region 400. When establishment of the winning combination is determined, the establishment of the winning combination is determined by replacing the WILD symbol with another symbol. The WILD symbol is replaced with another symbol such that an advantageous winning combination is established.

Note that, when the WILD symbol is stop-displayed in a stop position overlapping a plurality of valid pay lines 420, establishment of the winning combination is determined by replacing the WILD symbol for each of the pay lines 420.

### <Skill Game>

A skill game is a game for reflecting an operation skill of a player on a result of the game. In particular, in the skill game of the present embodiment, the player determines timing of stop operation and performs the stop operation (target object stop operation) aiming at stop-display of an object such as a symbol set as a target. The operation skill of the player is reflected on the determination of the timing of the stop operation.

For example, a video slot game or the like can be a game for stopping the scrolling video reel 410 with stop operation of the player and stopping the target symbol in a predetermined position. The skill game only has to be a game for not only stopping the video reel but also stopping a moving object moving on the main display 210 in a specified position.

### <Prize>

Prizes include granting of a payout (a slot game payout) by a result of the video slot game, transition to a bonus game, granting of a JACKPOT payout, and granting of a bonus game payout. The slot game payout is granting of a predetermined number of credits associated with a winning combination when the winning combination of a predetermined symbol is established in the video slot game. The JACKPOT payout includes MINI, MINOR, MAJOR, and GRAND.

The video slot game is sometimes played in a bonus game besides a base game. Therefore, the base game payout becomes a slot game payout and the bonus game payout becomes a slot game payout.

### <Payout>

A payout is a type of a prize and is granting of a credit. The payout is granting of a credit, a specific numerical value of which is decided, and a predetermined number of credits are granted to the player. The payout includes a bonus payout and a JACKPOT payout besides the slot game payout.

### Present Embodiment

The present embodiment will be explained below with reference to the drawings.

### <<<Configuration of a Gaming Machine 10>>>

FIG. 1 is a front view illustrating an exterior of a gaming machine 10 according to the present embodiment. The gaming machine 10 is a video slot machine. In the gaming machine 10, as in a mechanical slot machine in which a physical reel is driven by a motor or the like, establishment of a winning combination is determined by a symbol stop-displayed in the symbol display region 400. The gaming machine 10 only has to be a device that can make the transition from a base game serving as a reference to another game (a game more advantageous for a player than the base game is preferable). The gaming machine 10 provides not only a video slot game but also various games different from video slot game such as a roulette game, a pick game, a backgammon game, and a battle game.

As illustrated in FIG. 1, the gaming machine 10 mainly includes a main display 210, a sub-display 220, a control panel 300, and a controller 100.

<<Main display 210>>

The gaming machine 10 includes the main display 210 in substantially the center of the housing 12. The main display 210 includes, for example, a liquid crystal display panel 212 and a touch panel 340. The touch panel 340 is provided to be superimposed on the liquid crystal display panel 212. When the player touches the touch panel 340, an instruction corresponding to an image displayed on the liquid crystal display panel 212 can be inputted from the touch panel 340.

The main display 210 further includes a credit number display region and a payout number display region (not shown). In the number of credits display region, the number of credits owned by the player is displayed. In the payout number display region, the number of credits to be dispensed when a predetermined winning combination is established is displayed.

### <<Sub-Display 220>>

The gaming machine 10 includes the sub-display 220 in a lower part of the main display 210. The sub-display 220 includes, for example, a liquid crystal display panel 222 and a touch panel 350. The touch panel 350 is provided to overlap the liquid crystal display panel 222. The player can, by touching the touch panel 350, input, from the touch panel 350, an instruction corresponding to an image displayed on the liquid crystal display panel 222. The sub-display 220 can display and input information concerning BET, auxiliary information, and the like. The sub-display 220 functions as an interface screen for displaying and inputting various kinds of information concerning the progress of the game.

### <<Control Panel 300>>

The gaming machine 10 includes a control panel 300 below the main display 210. The control panel 300 mainly includes the BET button 320, the SPIN button 330, a card reading device 250, a bill depositing device 260, and a ticket dispensing device 270, and the like.

<BET Button 320 (320a, 320b, 320c, 320d, and 320e)>

The control panel 300 includes a BET button 320a, a BET button 320b, a BET button 320c, a BET button 320d, and a BET button 320e. In the following explanation, each of the five BET buttons 320a to 320e is simply referred to as the BET button 320 when it is not particularly necessary to distinguish the BET buttons 320a to 320e or when the BET buttons 320a to 320e cannot be distinguished.

The BET means deposit of a credit for executing (starting) a game. The number of BETs means a deposit number, a deposit volume, a deposit amount, and the like. The BET ratio means a ratio for determining the deposit number, the deposit volume, the deposit amount, and the like. A minimum number of BETs of the gaming machine 10 is, for example, 50 credits. The gaming machine 10 has seven BET select numbers. The BET selection number corresponds to the BET ratio. The BET ratio is allocated to each of the BET select numbers in advance.

### <BET Selection Number, BET Ratio, Number of Credits>

A BET ratio corresponding to a BET selection number 1 is 1 and the number of credits is 50 (=50×1). A BET ratio corresponding to a BET selection number 2 is 2 and the number of credits is 100 (=50×2). A BET ratio corresponding to a BET selection number 3 is 3 and the number of credits is 150 (=50×3). A BET ratio corresponding to a BET selection number 4 is 4 and the number of credits is 200 (=50×4). A BET ratio corresponding to a BET selection number 5 is 5 and the number of credits is 250 (=50×5). A BET ratio corresponding to a BET selection number 6 is 10 and the number of credits is 500 (=50×10). A BET ratio corresponding to a BET selection number 7 is 20 and the number of credits is 1000 (=50×20).

In this way, the gaming machine 10 has the seven BET selection numbers. Five BET selection numbers selected out of the BET selection numbers are allocated to the five BET buttons 320a, 320b, 320c, 320d, and 320e.

The gaming machine 10 has a manager mode. In the manager mode, the BET selection number (the BET ratio) allocated to each of the five BET buttons 320a to 320e can be changed by operation of a store clerk or the like. The BET selection number allocated to each of the BET buttons 320a to 320e is stored in the RAM 130.

### <SPIN Button 330>

Scrolling of the video reels 410a to 410e can be started by the player operating the SPIN button 330. As explained below, in the gaming machine 10 in the present embodiment, a skill game is executed. In the skill game, when a reel such as the video reel 410 is scrolled, the scrolling reel can be stopped by operating the SPIN button 330.

Note that, as explained above, the skill game only has to be a game for stopping not only the symbol of the video reel 410 but also the moving object in the designated position and only has to be a game for stopping the moving object with the operation of the SPIN button 330 by the player.

### <<<Hardware Configuration of the Gaming Machine 10>>>

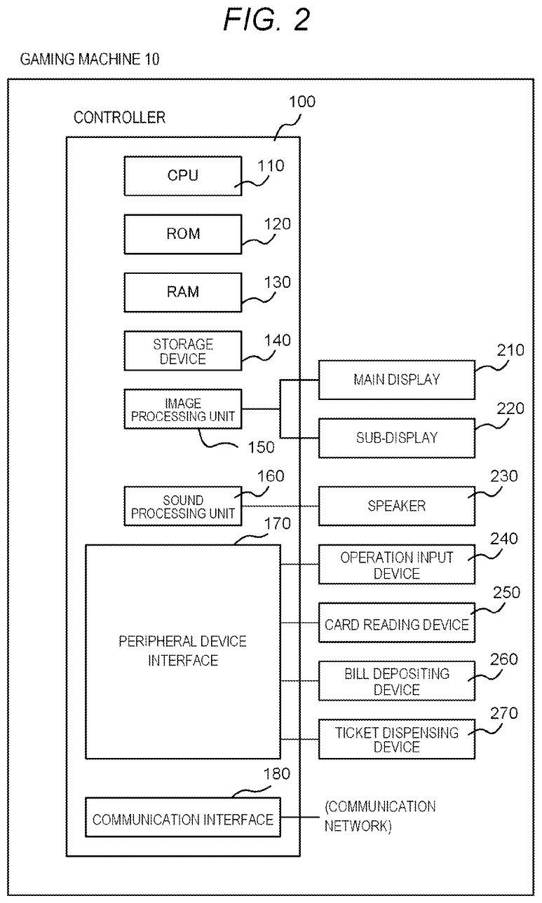

FIG. 2 is a block diagram illustrating a main hardware configuration of the gaming machine 10.

The controller 100 of the gaming machine 10 mainly includes a CPU (central processing unit) 110, a ROM (read only memory) 120, a RAM (random access memory) 130, a storage device 140, an image processing unit 150, a sound processing unit 160, a peripheral device interface 170, and a communication interface 180. These are connected via an input and output bus (not illustrated) to be capable of transmitting and receiving various commands and signals.

### <CPU 110, ROM 120, RAM 130>

The CPU 110 executes various kinds of processing such as an arithmetic operation. For example, the CPU 110 reads out and executes a game program stored in the storage device 140. The ROM 120 stores firmware and the like of the controller 100 and functions as one of main storage devices of the CPU 110. The RAM 130 functions as one of main storage devices of the CPU 110, develops and stores a program to be executed by the CPU 110, and temporarily stores a result of arithmetic processing of the CPU 110.

### <Storage Device 140>

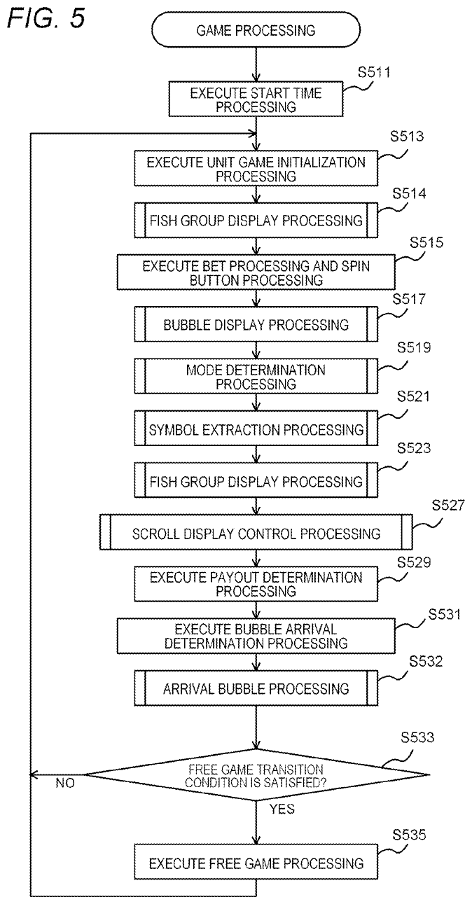

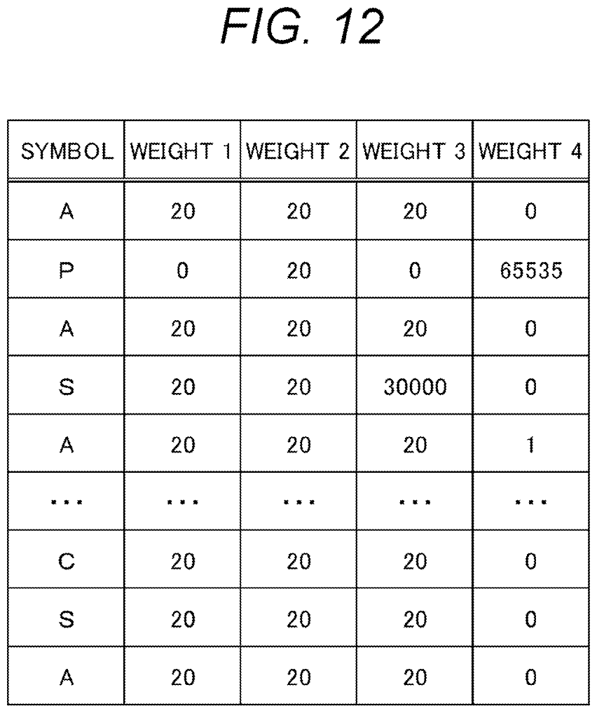

The storage device 140 functions as an auxiliary storage device of the CPU 110 and includes a hard disk drive (HDD), a solid state drive (SSD), and a non-volatile memory. The storage device 140 stores a program (FIG. 5 to FIG. 11 and the like referred to below), various tables (for example, a table (FIG. 12) defining a correspondence relation between an array of symbols and weights), image data of symbols, image data for performance, and audio data for performance.

### <Image Processing Unit 150>

The image processing unit 150 is connected to the main display 210. The CPU 110 outputs various commands and signals to the image processing unit 150. The image processing unit 150 displays various images on main display 210 according to a command or a signal from CPU 110. For example, the image processing unit 150 displays images of video reels 410a to 410e on the main display 210.

### <Sound Processing Unit 160>

The sound processing unit 160 is connected to a speaker 230. The CPU 110 outputs various commands and signals to the sound processing unit 160. The sound processing unit 160 supplies a sound signal for rendering to the speaker 230 according to a command or a signal output from the CPU 110.

### <Peripheral Device Interface 170>

The peripheral device interface 170 is connected to peripheral devices such as the operation input device 240, the card reading device 250, the bill depositing device 260, and the ticket dispensing device 270.

The operation input device 240 includes the BET buttons 320a to 320e, the SPIN button 330, and the touch panel 340. When the player operates the BET buttons 320a to 320e, a signal indicating a BET ratio is supplied to the CPU 110 via the peripheral device interface 170. When the player operates the SPIN button 330, a signal indicating spin start permission is supplied to the CPU 110 via the peripheral device interface 170. When the player operates the touch panel 340, a command or the like associated with an image displayed on the liquid crystal display panel 212 is supplied to the CPU 110 via the peripheral device interface 170.

The card reading device 250 reads information from a card owned by the player. The card stores play information of the player. For example, the card stores a point or the like acquired according to a gaming state of the player. The bill depositing device 260 reads a deposited bill or ticket. The ticket dispensing device 270 outputs a ticket to be granted to a player. On the ticket, the number of credits owned by the player is printed.

The gaming machine 10 can use bills, tickets, and electronic valuable information equivalent to these as game media. Game media are not limited to these and, for example, a medal, a token, electronic money, or the like can also be used.

### <Communication Interface 180>

The communication interface 180 is communicably connected to a management server via a network (not illustrated). The management server is installed in a casino, an amusement facility, or the like. In the management server, a command or a signal corresponding to operation by a store clerk or the like is supplied to the CPU 110 via the communication interface 180. For example, information concerning a progressive jack pot and the like are transmitted and received via the network.

### <Network 20 and Management Server 30>

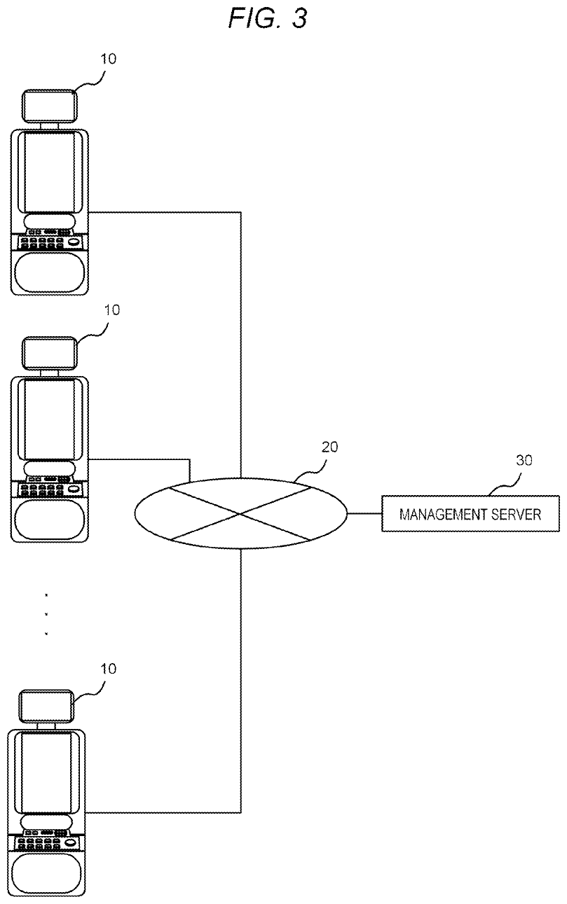

FIG. 3 is a diagram illustrating a plurality of gaming machines 10 connected to a network 20. The plurality of gaming machines 10 can be connected via the network 20. A management server 30 is connected to the network 20. Information concerning a progressive jack pot and the like is transmitted to and received from the management server 30 via the communication interface 180 of the gaming machine 10.

In the present embodiment, the gaming machines 10 can transmit and receive predetermined information (for example, information concerning winning of a mode E explaining below) one another. When one gaming machine 10 connected to the network 20 wins the mode E, the information concerning the winning of the mode E is transmitted to the other gaming machines 10 via the network 20. The information concerning the winning of the mode E can be shared among the gaming machines 10 connected to the network 20.

### <<<Types of Symbols>>>

The CPU 110 of the gaming machine 10 displays symbols on the main display 210. The gaming machine 10 includes the base game and the bonus game. The symbols are decided according to these games.

In the present embodiment, the gaming machine 10 mainly includes a bonus symbol, a general symbol, and a specific symbol. The bonus symbol is a symbol that can transition to the bonus game when the winning combination is established. The general symbol is a symbol to which a predetermined prize, for example, a predetermined payout is granted. The specific symbol is a symbol to which a predetermined prize, for example, transition to a bonus or a predetermined payout is granted by overlapping a bubble explained below and being stopped and displayed.

<<<Symbol Display Region 400 (Scroll Area) and Video Reels 410a to 410e>>>

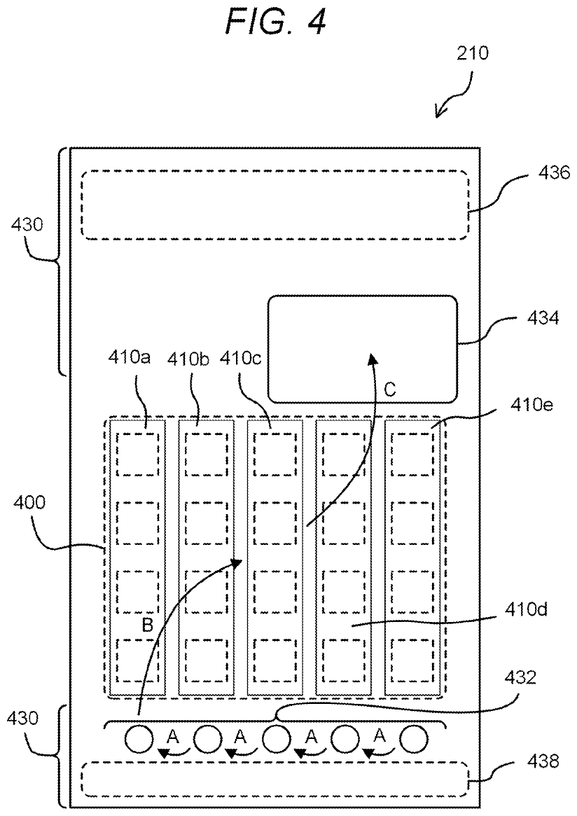

As illustrated in FIG. 1 and FIG. 4, the main display 210 includes the symbol display region 400. In the symbol display region 400, the five video reels 410a, 410b, 410c, 410d, and 410e are displayed. Note that, when it is not particularly necessary to distinguish the video reels 410a to 410e or the video reels 410a to 410e cannot be distinguished, the video reels 410a to 310e are simply referred to as video reel 410. A plurality of predetermined symbols are respectively allocated to the video reels 410a to 410e in predetermined order (FIG. 12). FIG. 12 is a table illustrating an example of the symbol table of the base game. The symbols are switched according to a type of a game.

The video reels 410a to 410e are scrolled and stopped in the symbol display region 400. In other words, the symbols are displayed to move or are stop-displayed in the symbol display region 400.

### <<<Stop Positions of Symbols and Rearrangement of the Symbols>>>

As illustrated in FIG. 4, in the present embodiment, the symbol display region 400 includes stop positions (cells) of symbols in 4 rows and 5 columns (squares indicated by broken lines in FIG. 4). The symbol display region 400 includes four rows extending in the horizontal direction. The four rows include an uppermost first row, an immediately lower second row, a further lower third row, and a lowermost fourth row. The symbol display region 400 includes five columns extending in the vertical direction. The five longitudinal lows include a leftmost first column, an immediately right second column, a further right third column, a further right fourth column, and a rightmost fifth column. The first column corresponds to the video reel 410a, the second column corresponds to the video reel 410b, the third column corresponds to the video reel 410c, the fourth column corresponds to the video reel 410d, and the fifth column corresponds to the video reel 410e.

When the video reels 410a to 410e are stopped, symbols are respectively stopped and displayed in the stop positions in 4 rows and 5 columns. That is, when the video reels 410a to 410e are stopped, twenty symbols in total are displayed (rearranged) in a matrix shape of 4 rows and 5 columns. As explained below, every time a unit game is played, a plurality of symbols are rearranged in the symbol display region 400 and a lottery result of the symbols in the unit game is displayed.

### <<<Pay Line 420>>>

The gaming machine 10 includes a plurality of pay lines 420 in the symbol display region 400 (not illustrated). In FIG. 1, only a part of the pay lines 420 is illustrated for convenience.

The pay line 420 is formed by connecting one stop position selected for each of the video reels 410a to 410e. Establishment of a winning combination is determined by a type and the number of symbols continuously arranged along the pay line 420 from a leftmost stop position (the video reel 410a). A target of the determination of the winning combination is arrangement of symbols continuously arranged from the leftmost stop position along the pay line 420.

### <<<Non-Scroll Area 430>>

As illustrated in FIG. 4, the main display 210 includes the non-scroll area 430. In the present embodiment, the symbol display region 400 explained above is sometimes referred to as scroll area as well.

### <<Non-Scroll Area 430>>

In the main display 210, an area other than the symbol display region 400 is the non-scroll area 430. The non-scroll area 430 includes pre-display region 432, an arrival display region 434, an upper gaming information display region 436, and a lower gaming information display region 438.

### <Pre-Display Region 432>

The pre-display region 432 is a region extending in the horizontal direction in a lower part of the main display 210. The pre-display region 432 is a region where an image of a bubble explained below (hereinafter simply referred to as bubble) is displayed. In the present embodiment, five bubbles are displayed in the pre-display region 432. In the pre-display region 432, the bubble transitions in the left direction (an arrow A in FIG. 4).

### <Arrival Display Region 434>

The arrival display region 434 is located at the upper right. The bubble moves from the pre-display region 432 to the symbol display region 400 (an arrow B) and thereafter moves to the arrival display region 434 (an arrow C). The arrival display region 434 is a region where the bubble moving from the symbol display region 400 arrives. In the arrival display region 434, a plurality of bubbles are displayed. The movement of the bubble in the main display 210 is explained in detail below.

### <Upper Gaming Information Display Region 436 and Lower Gaming Information Display Region 438>

The upper gaming information display region 436 is located in an upper part of the main display 210. The lower gaming information display region 438 is located in a lower part of the main display 210. In the upper gaming information display region 436 and the lower gaming information display region 438, various kinds of information concerning gaming, for example, information such as a payout in a unit game and the number of owned credits is displayed.

### <<<Winning Combination and a Payout (a Slot Game Payout)>>>

The gaming machine 10 has a correspondence relation between a winning combination and a payout (not illustrated). A plurality of winning combinations are defined and a predetermined payout is allocated to each of the winning combinations. The number of payouts is a credit value and is a value relating to a predetermined amount of money. The correspondence relation of the payout table is stored in advance in the storage device 140.

When symbol lottery processing is executed and a type and the number of symbols continuously arranged along the pay line 420 from the leftmost stop position (the video reel 410a) coincide with any winning combination, the winning combination is established and a payout corresponding to the winning combination is paid out (stored in the RAM 130).

When the player finishes a game of the gaming machine 10, the ticket dispensing device 270 prints the number of credits owned by the player on a ticket. In this way, it is possible to perform to adjust credits in the gaming machine 10.

### <<<Type of a Game and Transition>>>

### <<Base Game and Bonus Game>>

The gaming machine 10 includes the base game and the bonus game.

### <Base Game>

The base game has a video slot game. When a transition condition to the bonus game is satisfied in the base game, the game transitions to the bonus game. In this case, the game may directly transition from the base game to the bonus game or may be indirectly transitioned via another game.

### <Bonus Game (Feature Game)>

The bonus game includes a free game and a special game explained below. The bonus game only has to be a game having possibility of being more advantageous to the player than the base game. Like the base game, the bonus game may be the video slot game such as the free game, a roulette game, or the like. The bonus game may be a skill game in which an operation skill of the player is reflected on a result of the game. In order to display a stop of a target object such as a symbol targeted by the player, the player determines timing for stop operation and performs stop operation (target object stop operation). The operation skill of the player is reflected on the determination of the timing of the stop operation.

### <<<<Processing of the Gaming Machine 10>>>>

Processing of the gaming machine 10 is explained below with reference to FIG. 5 to FIG. 22. It is assumed that the gaming machine 10 has completed start-up processing such as initialization and is steadily operating. It is assumed that the reading device 250, the bill depositing device 260, and the like are operated by the player and a necessary credit is deposited.

### <<<Game Processing>>>

FIG. 5 is a flowchart illustrating game processing.

First, when the gaming machine 10 is powered on, the CPU 110 of the controller 100 reads a BIOS from the ROM 120 and executes the BIOS, thereafter reads a game program from the storage device 140, and loads and stores the game program in the RAM 130 in an executable manner (step S511).

Subsequently, the CPU 110 of the controller 100 executes initialization processing at the end of a unit game (step S513). For example, the number of BETs, symbols determined by the lottery processing, and the like are initialized. In the processing in step S513, the CPU 110 reduces the number of games.

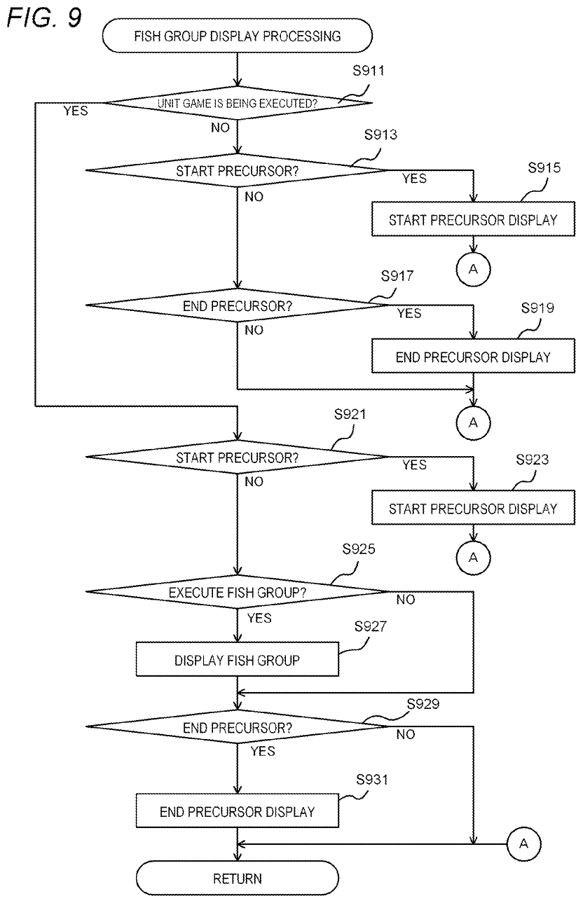

Subsequently, the CPU 110 of the controller 100 invokes and executes fish group display processing illustrated in FIG. 9 (step S514). The fish group display processing is processing for displaying a video of a fish group on the main display 210.

By the fish group display processing, in the gaming machine 10 that has won the mode E, precursor display can be started or ended at timing before the unit game is started. By the fish group display processing, when information concerning winning of the mode E is received from another gaming machine 10 via the network 20, the precursor display can also be started or ended at the timing before the unit game is started.

Subsequently, the CPU 110 of the controller 100 executes BET processing and SPIN button processing (step S515). In this processing, it is determined whether the BET button 320 and the SPIN button 330 are operated by the player. Processing of the number of credits owned by the player is executed.

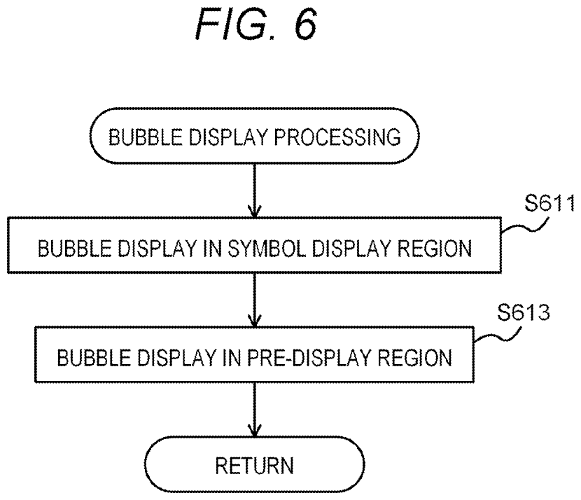

Subsequently, the CPU 110 of the controller 100 invokes and executes bubble display processing illustrated in FIG. 6 (step S517). The bubble is a pattern (identification information) managed separately from a symbol used in the video slot game.

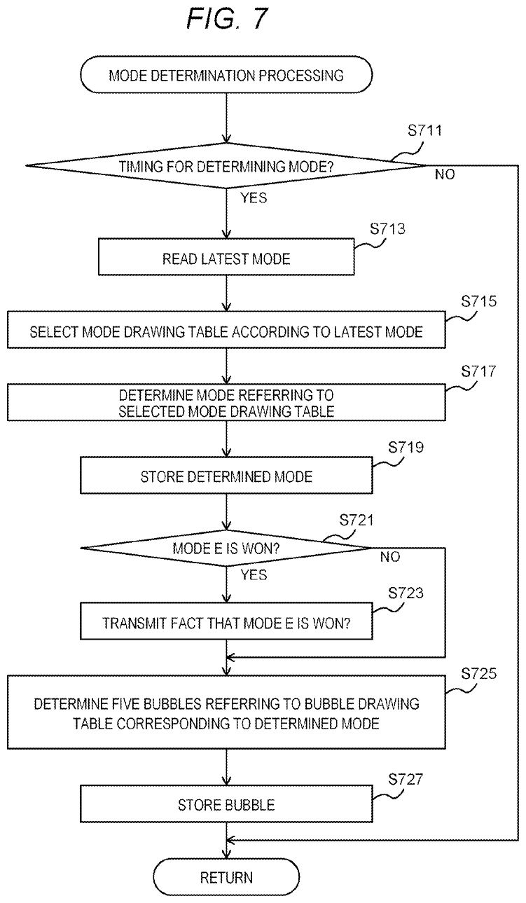

Subsequently, the CPU 110 of the controller 100 invokes and executes mode determination processing illustrated in FIG. 7 (step S519). The mode is an index for deciding a type of a bubble. There are a plurality of modes and rates at which types of bubbles are selected are different from one another in the modes. Display content of the bubble is allocated to the type of the bubble. The display content of the bubble is determined by the type of the bubble. The display content of the bubble may be a character, a figure, or a picture. Specifically, the mode is identification information for identifying a difference in a winning probability of the type of the bubble when the type of the bubble is determined by the lottery processing. The type of the bubble is determined by the lottery processing and the display content displayed as the bubble is determined according to the type of the bubble.

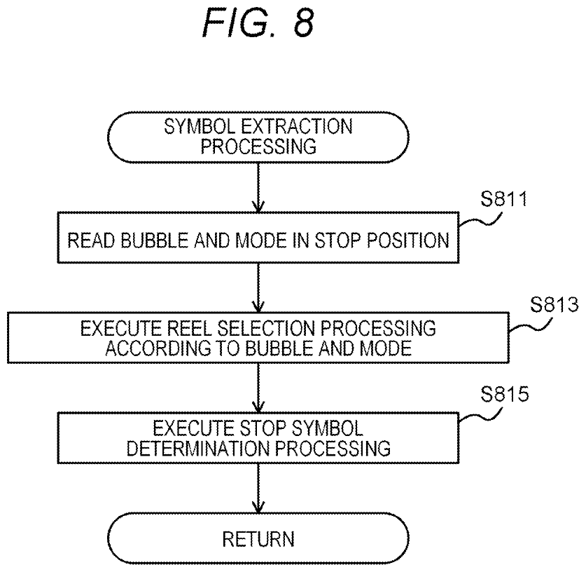

Subsequently, the CPU 110 of the controller 100 invokes and executes the symbol lottery processing illustrated in FIG. 8 (step S521). The symbol lottery processing is processing for determining a symbol used in the video slot game, which is the base game.

Subsequently, the CPU 110 of the controller 100 invokes and executes the fish group display processing illustrated in FIG. 9 (step S523). The fish group display processing is processing for displaying a video of a fish group on the main display 210. When the mode E is won in the processing of step S519, the precursor display can be started or ended.

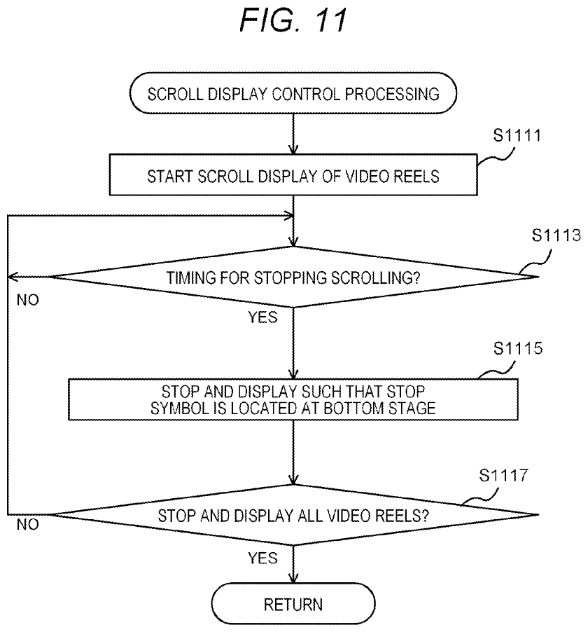

Subsequently, the CPU 110 of the controller 100 invokes and executes scroll display control processing illustrated in FIG. 11 (step S527). The scroll display control processing is processing for controlling scroll display of the video slot game, which is the base game. With this processing, the five video reels 410a to 410e are scrolled and then stopped in the symbol display region 400 of the main display 210. In this way, twenty symbols in total are rearranged in a matrix of 4 rows and 5 columns.

Subsequently, the CPU 110 of the controller 100 determines the number of payouts (step S529). With this processing, a payout is calculated by calculating a sum of a base game payout (a slot game payout), a bonus payout, a JACKPOT payout, and the like.

Subsequently, the CPU 110 of the controller 100 executes bubble arrival determination processing (step S531). With this processing, it is possible to determine whether to move bubbles located in the first row of the symbol display region 400 to the arrival display region 434.

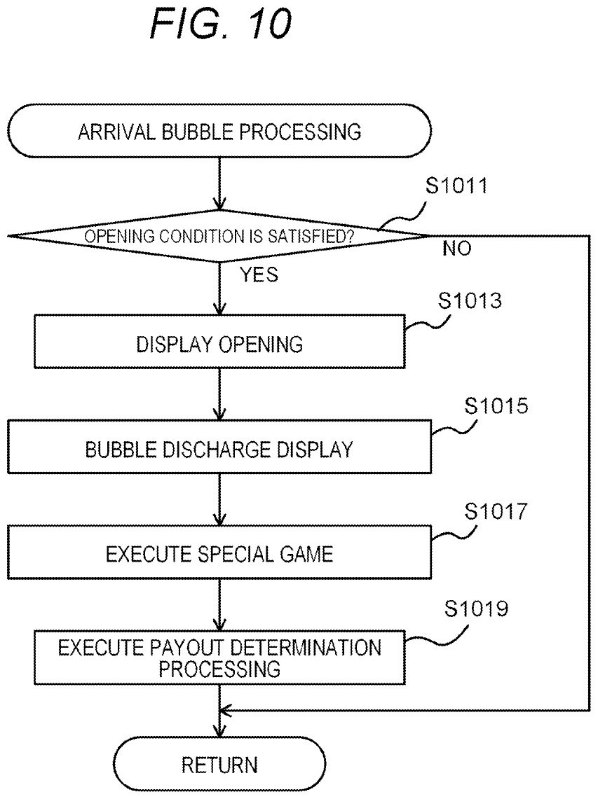

Subsequently, the CPU 110 of the controller 100 invokes and executes arrival bubble processing illustrated in FIG. 10 (step S532). The arrival bubble processing is processing for displaying bubbles in the arrival display region 434 or displaying a state of the arrival display region 434.

Subsequently, the CPU 110 of the controller 100 determines whether a free game transition condition is satisfied (step S533). The free game transition condition can be, for example, that a winning combination of a bonus symbol is established.

When determining in the determination processing in step S533 that the free game transition condition is satisfied (YES), the CPU 110 of the controller 100 executes the free game processing (step S535). In this way, it is possible to transition from the base game to the free game.

When determining in the determination processing in step S533 that the free game transition condition is not satisfied or executing the processing of step S535, the CPU 110 of the controller 100 returns the processing to step S513.

### <<<Bubble Display Processing>>>

FIG. 6 is a flowchart illustrating bubble display processing. As explained above, the bubbles are displayed in the three regions of the pre-display region 432, the symbol display region 400 of the main display 210, and the arrival display region 434. The bubble display processing illustrated in FIG. 6 controls bubbles to be displayed in the pre-display region 432 and the symbol display region 400 of the main display 210.

### <<Bubbles to be Displayed in the Symbol Display Region 400>>

First, the CPU 110 of the controller 100 controls bubbles to be displayed in the symbol display region 400 (step S611). The processing of step S611 includes processing for moving bubbles already displayed in the symbol display region 400 and processing for moving the bubbles from the pre-display region 432 to the symbol display region 400.

### <Processing for Moving Bubbles Already Displayed in the Symbol Display Region 400>

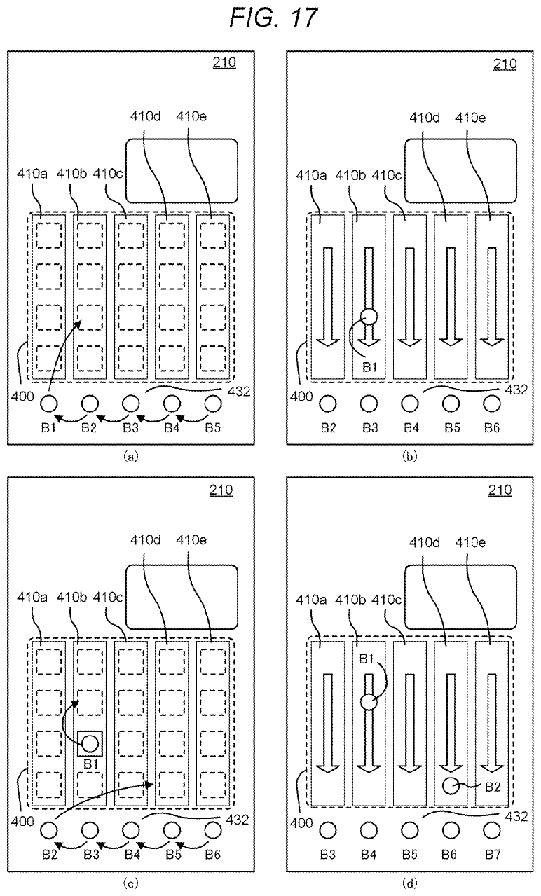

First, in processing of step S611, the bubbles already displayed in the symbol display region 400 are moved to immediately higher stop positions and stopped and displayed. As explained above, the symbol display region 400 includes the stop positions of the symbols in 4 rows and 5 columns. In the symbol display region 400, positions where bubbles are stopped and displayed are common to positions where the symbols are stopped and displayed. Therefore, when the video reels 410a to 410e are stopped and the symbols are rearranged, the bubbles stopped and displayed are displayed to overlap the symbols stopped and displayed. The display of the specific movement of the bubbles is explained below (FIG. 17 to FIG. 19).

In the present embodiment, the bubbles already displayed in the symbol display region 400 move vertically to the immediately higher stop positions. That is, the bubbles move along the same video reel. Note that the bubbles may be moved to stop positions of different reels. Note that the scrolling stops after the bubbles move.

### <Symbol Display Region Management Table>

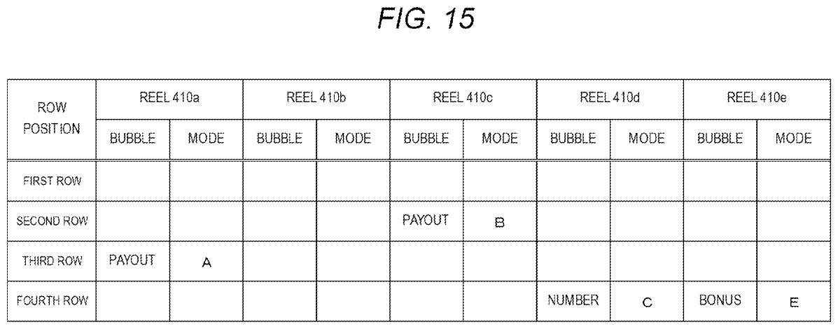

The bubble movement processing is performed using a symbol display region management table illustrated in FIG. 15. FIG. 15 is a management table for managing types of bubbles displayed in the symbol display region 400 and modes of the bubbles. The symbol display region management table illustrated in FIG. 15 stores types of bubbles stopped and displayed in stop positions of the 4×5 symbols in the symbol display region 400 and modes corresponding to the bubbles. When the bubbles are stopped and displayed in the symbol display region 400, types and modes of the bubbles are stored in cells of the symbol display region management table corresponding to the stop positions.

When the unit game starts, stop positions of the bubbles at that time are specified from places of the cells of the symbol display region management table in which the bubbles are stored. Subsequently, immediately higher stop positions of the specified stop positions are determined as new stop positions. Subsequently, the bubbles are moved to the new stop positions and displayed. Subsequently, the types of the bubbles and the modes corresponding to the bubbles are stored in cells corresponding to the new stop positions in the symbol display region management table.

<Processing for Moving Bubbles from the Pre-Display Region 432 to the Symbol Display Region 400>

Further, in the processing of step S611, the bubbles displayed in the pre-display region 432 are moved to the symbol display region 400 and displayed. As illustrated in FIG. 4 and the like, five bubbles are displayed in the pre-display region 432 in the horizontal direction. In the present embodiment, a bubble displayed on the leftmost side among the five bubbles is moved to the symbol display region 400 and stopped and displayed (see an arrow B in FIG. 4). A position where the bubble is stopped and displayed is determined by the lottery processing. Any one of 15 stop positions in the first to fifth columns and the second to fourth rows (3×5) is determined by the lottery processing. Note that it is preferable to increase a ratio at which the bubbles are displayed in the fourth row in order to increase opportunities for the player to acquire prizes of the bubbles.

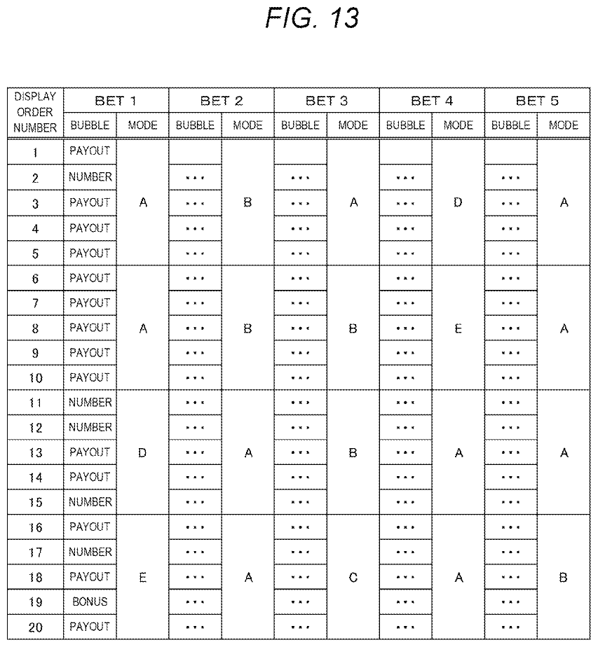

This processing is performed using a pre-bubble management table illustrated in FIG. 13 and a symbol display region management table illustrated in FIG. 15.

### <Pre-Bubble Management Table>

FIG. 13 is a management table for managing types of bubbles and modes of the bubbles before the bubbles are displayed in the symbol display region 400. Five bubbles of display order numbers 1 to 5 are types of bubbles displayed in the pre-display region 432 in a unit game at that point in time. Fifteen bubbles of display order numbers 6 to 20 have not been displayed in the pre-display region 432 yet.

When the next unit game is started, the bubble of the display order number 1 is displayed in the symbol display region 400. Bubbles and modes stored in the display order numbers 2 to 20 are shifted to the display order numbers 1 to 19. Every time the unit game is started, the display order numbers of the bubbles and the modes decrease one.

When the unit game starts, first, the type and the mode of the bubble stored in the display order number 1 of the pre-bubble management table in FIG. 13 is read out. Subsequently, as explained above, a new stop position is determined by the lottery processing. Subsequently, the bubble is moved to the determined new stop position and displayed. Subsequently, the type of the bubble and the mode corresponding to the bubble are stored in a cell corresponding to the new stop position in the symbol display region management table in FIG. 15.

Note that, as illustrated in FIG. 13, the pre-bubble management table is configured to store types and modes of bubbles for each of five BET1 to BET5. The five BET1 to BET5 are explained below.

### <Types and Functions of Bubbles>

As explained above, when the symbols are rearranged in the symbol display region 400, the bubbles stopped and displayed are displayed to overlap the symbols stopped and displayed. When a specific symbol among the symbols is stopped and displayed to overlap a bubble, a predetermined prize, for example, transition to a bonus or a predetermined number of payouts is granted. The prize is determined by a type of bubble.

Types of bubbles include a payout bubble, a number bubble, a large bubble, a bonus bubble, and a jackpot bubble. As the jackpot bubble, there are four types of a GRAND bubble, a MAJOR bubble, a MINOR bubble, and a MINI bubble. When these jack pot bubbles move to the symbol display region 400 and are stopped and displayed to overlap the specific symbol, the JACKPOT payout (GRAND, MAJOR, MINOR, MINI) explained above is decided.

When the payout bubble is stopped and displayed to overlap the specific symbol, a payout associated with the payout bubble is granted. As the payout bubble, there are various bubbles of payouts such as a low payout bubble and a high payout bubble.

The number bubble is a bubble indicating the number of bubbles displayed in the symbol display region 400. The number of bubbles is determined by the lottery processing or the like. As the number bubble, in the pre-display region 432, a group of a predetermined number of small bubbles is displayed as a single bubble. When the number bubble moves to the symbol display region 400, the number bubble is split into a predetermined number of bubbles and displayed in the symbol display region 400.

The number bubble may be either the payout bubble or the bonus bubble. A type of the bubble is also determined by the lottery processing.

When the number bubble is the payout bubble, when the number bubble is displayed in the pre-display region 432, a payout is not displayed and payouts are displayed in the bubbles that have moved to the symbol display region 400 and split. The payouts displayed in the respective plurality of split bubbles may be the same or different. When the number bubble is the bonus bubble, when the number bubble is displayed in the pre-display region 432, the fact that the number bubble is the bonus is not displayed and the fact that the number bubble is the bonus is displayed in the bubble that has moved to the symbol display region 400 and split.

There is a split bubble as a bubble similar to the number bubble. The split bubble is displayed as only one bubble in the pre-display region 432 and are split into a plurality of bubbles and displayed when moving to the symbol display region 400. A type of the split bubble may be either the payout bubble or the bonus bubble. The number of split bubbles and a type of bubbles can be determined by the lottery processing. When the split bubble is divided and displayed in the symbol display region 400, the fact that the type of the bubble is a payout or a bonus is displayed in each of the plurality of bubbles. The payout displayed for each of the plurality of bubbles may be the same or different.

The large bubble is a bubble larger than a normal bubble. The normal bubble is a bubble that occupies only one stop position. The large bubbles occupy a plurality of stop positions. For example, the large bubble is the large bubble displayed to overlap a plurality of stop positions such as 2×2 stop positions, 3×3 stop positions, and 4×4 stop positions. When the large bubble overlaps a specific symbol and is stopped and displayed, a prize of the large bubble is determined according to the number of all specific symbols included in a region of the large bubble. Note that the shape of the large bubble may be 2×1 stop positions, 3×2, 3×1 stop positions, 4×3, 4×2, 4×1 stop positions, or the like.

When the bonus bubble is stopped and displayed to overlap the specific symbol, transition to the free game is determined. For example, the game can transition to the free game from the next unit game.

The bubbles may be bubbles or notifying the player of the possibility of progress of the game beforehand. The notification can be displaying characters indicating the possibility of the game to be displayed on the bubbles or displaying an image indicating the possibility of the game as the bubbles. The notification only has to be information that can be visually recognized by the player. For example, characters of “chance”, “!!”, or the like are displayed in the bubbles. When the bubbles are used in this way, when the game is started, one bubble displayed on the leftmost side in the pre-display region 432 is erased.

### <<Bubbles Displayed in the Pre-Display Region 432>>

Subsequently, the CPU 110 of the controller 100 controls bubbles to be displayed in the pre-display region 432 (step S613).

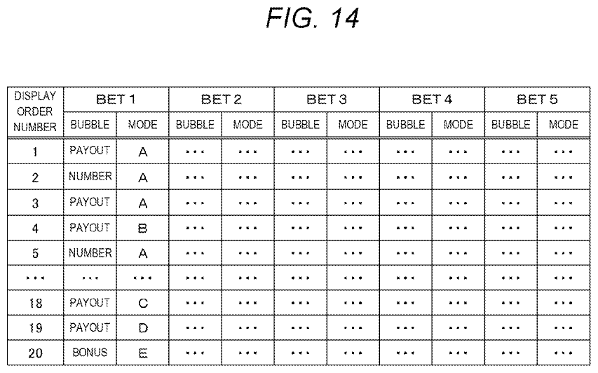

As explained above, as illustrated in FIG. 4, the five bubbles can be displayed in the pre-display region 432 in the horizontal direction. By the processing of step S611, one bubble displayed on the leftmost side has already moved to the symbol display region 400. Therefore, no bubble is displayed in the leftmost position in the pre-display region 432 and a bubble is displayed in each of the remaining four positions. In step S613, four bubbles are shifted in the left and displayed in the pre-display region 432 (see the arrow A in FIG. 4). Consequently, a bubble is displayed in each of four positions from the leftmost position in the pre-display region 432 and a bubble of a display order number 6 in FIG. 13 or FIG. 14 is displayed at the rightmost position as explained below.

This processing is performed using the pre-bubble management table illustrated in FIG. 13.

The display order number 1 of the pre-bubble management table corresponds to the leftmost position of the pre-display region 432. The bubble of the display order number 1 of the pre-bubble management table is displayed in the leftmost position.

The display order number 2 of the pre-bubble management table corresponds to a second position from the leftmost position in the pre-display region 432. A bubbles of the display order number 2 in the pre-bubble management table is displayed at the second position from the leftmost position.

The display order number 3 of the pre-bubble management table corresponds to a third position from the leftmost position in the pre-display region 432. A bubble of the display order number 3 in the pre-bubble management table is displayed in the third position from the leftmost position.

The display order number 4 of the pre-bubble management table corresponds to a fourth position from the leftmost position in the pre-display region 432. A bubble of the display order number 4 of the pre-bubble management table is displayed in the fourth position from the leftmost position.

The display order number 5 of the pre-bubble management table corresponds to a fifth position (the rightmost position) from the leftmost position in the pre-display region 432. A bubble of the display order number 5 of the pre-bubble management table are displayed in the rightmost position.

The display order numbers 6 to 20 of the pre-bubble management table does not correspond to the pre-display region 432 and the bubbles of the display order numbers 6 to 20 are not displayed in the pre-display region 432.

A type and a mode of the bubble stored in the display order number 2 of the pre-bubble management table are read and shifted to the display order number 1. Subsequently, the bubble stored in the display order number 2 are moved in the left direction by one and displayed. That is, the bubble stored in the display order number 2 are displayed in the leftmost position. Similarly, while a type and a mode of the bubble stored in each of the display order numbers 3 to 6 are read and shifted to the display order numbers 2 to 5, the bubble stored in each of the display order numbers 3 to 5 are moved by one in the left direction and displayed. Further, the bubble stored in the bubble stored in the display order number 6 is displayed in the rightmost position.

Similarly, a type and a mode of the bubble stored in each of the display order numbers 7 to 20 of the pre-bubble management table are shifted to the display order numbers 6 to 19.

### <Change of the Pre-Bubble Management Table>

Every time the unit game is started, the types and modes of the bubbles stored in the pre-bubble management table are shifted with the display order numbers reduced by one. Therefore, every time the unit game is started, the cells of the types and modes of the bubbles having the large display order numbers are gradually emptied. For example, when the types and the modes of the bubbles are stored in all the display order numbers 1 to 20, when the unit game is started, the types and modes of the bubbles of the display order numbers 2 to 20 are shifted to the display order numbers 1 to 19 and the cells of the type and the mode of the bubble of the display order number 20 is emptied. Subsequently, when the unit game is started, the types and modes of the bubbles of the display order numbers 2 to 19 are shifted to the display order numbers 1 to 18 and the cells of the type and the mode of the bubble of the display order number 19 is emptied. As explained above, every time the unit game is executed, the cells of the types and the mode of the bubbles are emptied in the descending order of the display order numbers in such a manner as the display order numbers 20, 19, and 18.

### <Processing in Steps S611 and S613>

In steps S611 and S613, at the start of the unit game, the bubbles already displayed in the symbol display region 400 are moved, one bubble displayed in the pre-display region 432 is moved to the symbol display region 400, and the four bubbles displayed in the pre-display region 432 are shifted.

In the pre-bubble management table illustrated in FIG. 13, five bubbles are associated with one mode. Correspondence between modes and bubbles is not limited this. For example, in the case of the pre-bubble management table illustrated in FIG. 14, one bubble may be associated with one mode. In this way, a mode can be changed for each unit game and the progress of a game can be easily changed.

### <<<Mode Determination Processing>>>

FIG. 7 is a flowchart illustrating mode determination processing. A mode is identification information for determining a type of a bubble. In the present embodiment, there are five modes of a mode A to a mode E.

The mode A is a mode in which a bubble with a low payout is likely to be won. The mode B is a mode in which a bubble with a high payout is likely to be won. The mode C is a mode in which the bonus bubble is easily won. The mode D is a mode in which bubbles are hardly generated. The mode E is a mode in which it is extremely easy to shift to the free game. By executing the processing in FIG. 7, one of the modes A to E is determined.

First, the CPU 110 of the controller 100 determines whether it is timing for determining a mode (step S711). The timing for determining a mode can be set to timing when an erased mode (an empty cell) is present by shifting types and modes of bubbles in ascending order of display. The number of erased modes may be one or all. If there is an erased mode, this can be timing for determining a mode.

When determining in step S711 that it is not timing for determining a mode (NO), the CPU 110 of the controller 100 immediately ends this subroutine.

When determining in step S711 that it is timing for determining a mode (YES), the CPU 110 of the controller 100 reads the latest mode (a mode determined immediately before) from the pre-bubble management table (step S713). In the pre-bubble management table, the modes are determined and stored in order from the top. Therefore, the latest mode is a mode described in the bottom cell of the pre-bubble management table and is a mode determined last.

Subsequently, the CPU 110 of the controller 100 selects a mode lottery table according to the read latest mode (step S715).

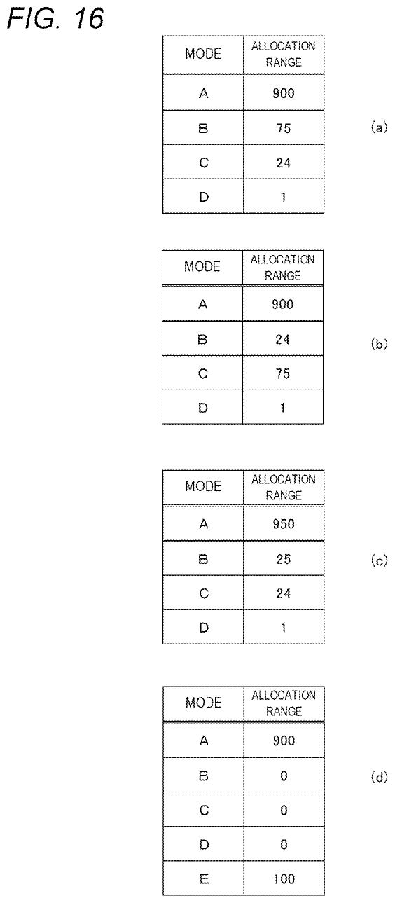

The selection of the mode lottery table is determined according to the immediately preceding mode, that is, the latest mode. For example, as the mode lottery table, there are four tables of tables (a) to (d) illustrated in FIG. 16. When the latest mode is A, the table (a) is selected as the mode lottery table. When the latest mode is B, the table (b) is selected as the mode lottery table. When the latest mode is C, the table (c) is selected as the mode lottery table. When the latest mode is D, the table (d) is selected as the mode lottery table. In this way, the modes can be determined in chains.

### <Mode Lottery Table>

FIG. 16 is a table illustrating the four mode lottery tables (a) to (d) defining a relation between modes and allocation ranges.

The mode lottery table (a) is defined such that the modes are easily selected in the order of the modes A, B, C, and D. The mode lottery table (b) is defined such that the modes are easily selected in the order of the modes A, C, B, and D. The mode lottery table (c) is defined such that the modes are easily selected in the order of the modes A, B or C, and D. The modes B and C are defined to be easily selected in substantially the same degree. In the mode lottery table (d), only the mode A or E is selected and the modes are easily selected in the order of the modes A and E. The mode E is selected only when the mode lottery table (d) is selected.

Subsequently, the CPU 110 of the controller 100 refers to the selected mode lottery table and determines one mode among the mode A to the mode E with the lottery processing (step S717).

Subsequently, the CPU 110 of the controller 100 stores the determined mode in the pre-bubble management table (step S719). In this way, the plurality of modes determined in chains are determined beforehand at a point in time before a unit game is started.

Subsequently, the CPU 110 of the controller 100 determines whether the mode E is won (step S721).

When the mode E is won (YES), the CPU 110 of the controller 100 transmits the fact that the mode E is won to the other gaming machines 10 (step S723). That is, the CPU 110 of the controller 100 transmits the fact that it is easy to shift to the free game to the other gaming machines 10 via the network 20. Consequently, fish group display explained below can be executed in all the gaming machines 10 connected to the network 20. The fish group display is explained below.

When the mode E is not won (NO) and the processing of step S723 is executed, the CPU 110 of the controller 100 determines a bubble referring to the bubble lottery table corresponding to the determined mode (step S725). For example, in the case of the pre-bubble management table illustrated in FIG. 13, five bubbles are determined. In the case of the pre-bubble management table illustrated in FIG. 14, one bubble is determined.

The CPU 110 of the controller 100 stores the determined bubbles in the pre-bubble management table (step S727), and ends this subroutine.

According to the plurality of modes determined in chains and beforehand, a plurality of bubbles can be determined beforehand at a point in time before the unit game is started.

### <<<Processing Corresponding to BET Operation>>>

The pre-bubble management table illustrated in FIG. 13 and FIG. 14 stores a mode and a bubble for each of the BET1 to BET5. The gaming machine 10 includes five BET buttons 320a, 320b, 320c, 320d, and 320e. Different BET ratios are respectively associated with the five BET buttons 320a, 320b, 320c, 320d, and 320e. The player can start the unit game at a desired BET ratio by selecting any one of the BET buttons 320a to 320e at the start of the unit game.

After advancing the unit game at one BET ratio, the player can start the unit game from the next unit game by changing the BET ratio to another BET ratio. For example, after advancing the unit game at a low BET ratio, the player can start the unit game by switching to the BET ratio to a high BET ratio with expectation of a high payout. Conversely, after advancing the unit game at a high BET ratio, the player can start the unit game by switching the BET ratio to a low BET ratio in order to suppress a decrease in owned credit.

The pre-bubble management table illustrated in FIG. 13 and FIG. 14 stores a mode and a type of a bubble for each of the BET1 to BET5. The processing in FIG. 6 and FIG. 7 is executed for a mode and a type of a bubble of a BET corresponding to the BET button 320 operated by the player among the BET1 to BET5. That is, only a mode and a type of a bubble corresponding to a BET ratio designated by the player are updated and a mode and a type of a bubble corresponding to a BET ratio not designated by the player are maintained without being updated.

Not only in the processing in FIG. 6 and FIG. 7 and internal processing such as the pre-bubble management table, when the player switches the BET ratio, the bubbles displayed in the symbol display region 400 and the non-scroll area 430 and the symbols of the video reels 410a to 410e are also switched.

With such a configuration, even if the unit game is initially advanced at a low BET ratio and, when a bubble having a high profit moves to the symbol display region 400, the low BET ratio is switched to a high BET ratio, the unit game is changed to a bubble, a mode, and the video reels 410a to 410e corresponding to the switched BET ratio. Therefore, it is possible to prevent the player from unreasonably obtaining a high payout. In addition, conversely, even when the BET ratio is switched from the high ratio to the low ratio, it is also possible to prevent a payout to be obtained from becoming unreasonably low. By switching the BET ratio, it is possible to prevent an excessive profit or an excessively small profit.

Further, as explained above, since the bubbles and the modes are managed by the pre-bubble management table illustrated in FIG. 13 and FIG. 14, when the unit game is not advanced and the BET ratio is returned to the original one BET ratio after being switched from one BET ratio to another BET ratio, the display of the symbol display region 400 and the non-scroll area 430 and the bubbles and the modes read from the pre-bubble management table are also returned to the original.

### <<<Symbol Lottery Processing>>>

FIG. 8 is a flowchart illustrating the symbol lottery processing.

First, the CPU 110 of the controller 100 reads a type and a mode of a bubble from the symbol display region management table illustrated in FIG. 15 (step S811). Consequently, the CPU 110 of the controller 100 acquires types of all bubbles stopped and displayed in stop positions in the symbol display region 400 and modes corresponding to the bubbles.

Subsequently, the CPU 110 of the controller 100 selects, according to the type and the mode of the bubble, a reel to be used for the next unit game (step S813).

For example, when the bonus bubble corresponding to the mode E is stopped and displayed, a reel on which the specific symbol is likely to be stopped and displayed is selected. Consequently, the bonus bubble and the specific symbol are easily stopped and displayed to overlap and, when the bonus bubble and the specific symbol are stopped and displayed to overlap, transition to the free game is decided.

Not only the bonus bubble corresponding to the mode E, when the bonus bubble is stopped and displayed in the stop position in the symbol display region 400, a reel not including the bonus symbol is selected. The transition to the bonus game by the bonus bubble and the transition to the free game by the bonus symbol can be prevented from simultaneously occurring (conflicting) in one unit game.

Subsequently, the CPU 110 of the controller 100 executes the lottery processing using weight associated with the selected reel, determines a stop symbol (step S813), and ends this subroutine.

For example, as illustrated in FIG. 12, a plurality of types of weights are allocated to one reel. FIG. 12 is a table defining a correspondence relation between an array of symbols of one reel and weights assigned to the symbols.

In weight 1, all symbols except a symbol P (a specific symbol) are determined by lottery at an equal probability. In weight 2, the all symbols are determined by lottery at an equal probability. In weight 3, a symbol S is determined by lottery at a probability at which the symbol S is most likely to be won. In weight 4, the symbol P (the specific symbol) is most likely to be won and the symbols other than the symbol A are determined by lottery with probabilities at which the symbols are not won.

Weight can be selected according to a bubble stopped and displayed in the symbol display region 400, a mode corresponding to the bubble, and the like, and the lottery processing according to the selected weight can be performed.

### <<<Fish Group Display Processing>>>

FIG. 9 is a flowchart illustrating fish group display processing.

First, the CPU 110 of the controller 100 determines whether a unit game is being executed (step S911).

When determining that the unit game is not being executed (NO), the CPU 110 of the controller 100 determines whether to start precursor display (step S913). For example, when the gaming machine 10 that has not won the mode E is receiving information concerning winning of the mode E from another gaming machine 10, the CPU 110 of the controller 100 determines to start the precursor display. The gaming machine 10 that has not won the mode E receives the information concerning winning of the mode E transmitted from another gaming machine 10 that has won the mode E. Consequently, the CPU 110 of the controller 100 of the gaming machine 10 that has not won the mode E can determine to start the precursor display.

In this way, the precursor display can be started in the plurality of gaming machines 10 connected by the network 20 irrespective of whether or not the mode E is won. For example, the precursor display can be performed in all gaming machines 10 connected by the network 20.

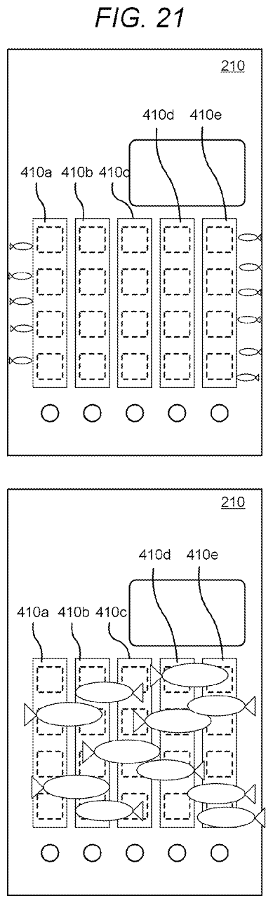

When determining in step S913 to start the precursor display (YES), the CPU 110 of the controller 100 starts the precursor display (step S915), and ends this subroutine. For example, as illustrated in the upper diagram of FIG. 21, fish groups including groups of small fish are displayed in a left region and a right region sandwiching the symbol display region 400 of the main display 210. Since the fish groups including the groups of small fish are displayed, it is possible to cause the player to expect that there is possibility of advantage for the player in the future such as transitioning to the free game.

Note that, in the upper diagram of FIG. 21, an example is illustrated in which the fish groups are displayed on the left and the right sandwiching the symbol display region 400. However, information indicating the precursor may be displayed in another non-scroll area 430. The information indicating the precursor may be displayed in the symbol display region 400 if the display does not hinder the progress of the game.

When determining in step S913 not to start the precursor display (NO), the CPU 110 of the controller 100 determines whether to end the precursor display (step S917).

When the SPIN button 330 is no longer operated by the player, for example, when the player finishes the game, and the game does not proceed, the CPU 110 of the controller 100 determines to end the precursor display when a predetermined time has elapsed.

Further, the gaming machine 10 that has not won the mode E also determines to end the precursor display when receiving, from the gaming machine that has won the mode E, information indicating that the transition to the free game by the mode E is decided.

When determining in step S917 to end the precursor display (YES), the CPU 110 of the controller 100 ends the precursor display (step S919). According to the end of the precursor display, the CPU 110 of the controller 100 erases the displayed fish groups from the main display 210.

When determining in step S917 not to end the precursor display (NO), the CPU 110 of the controller 100 ends this subroutine.

When determining in the determination processing of step S911 that the unit game is being executed (YES), the CPU 110 of the controller 100 determines whether to start the precursor display during the execution of the unit game (step S921). For example, when the bubble of the mode E is won or a predetermined number or more of payout bubbles are won, the CPU 110 of the controller 100 determines to start the precursor display.

When determining in step S921 to start the precursor display (YES), the CPU 110 of the controller 100 starts the precursor display (step S923) and ends this subroutine. For example, as in step S915, as illustrated in the upper diagram of FIG. 21, the CPU 110 of the controller 100 displays fish groups including groups of small fish in a left region and a right region sandwiching the symbol display region 400 of the main display 210. Since the fish groups including the groups of small fish are displayed, it is possible to cause the player to expect that there is possibility of advantage for the player in the future such as transitioning to the free game.

When determining in step S921 not to start the precursor display (NO), the CPU 110 of the controller 100 determines whether to display the fish groups (step S925).

For example, in the gaming machine 10 that has won the mode E, when the shift to the bonus game is decided by the bonus bubble corresponding to the mode E that has won, when the granting of a payout associated with a predetermined number or more of payout bubbles is decided, when the winning combination by the bonus symbol is established and the shift to the bonus game is decided, or when the winning combination by the predetermined number or more of payout symbols is established and the payout is decided, the CPU 110 of the controller 100 determines to display the fish group.

In the gaming machine 10 that has not won the mode E, when the shift to the bonus game is decided by the bonus bubble, when the winning combination by the bonus symbol is established and the shift to the bonus game is decided, or when the winning combination by a predetermined number or more of the payout symbols is established and the payout is decided, the CPU 110 of the controller 100 determines to display the fish groups.

When determining in step S925 to display the fish group (YES), the CPU 110 of the controller 100 displays a fish group including a group of large fish (step S927). By the processing of step S927, as illustrated in (a) of FIG. 21, the fish group including the group of large fish is displayed to overlap the symbol display region 400. The fish group including the group of large fish is displayed until a predetermined time elapses.

In the gaming machine 10 that has won the mode E, after the fish group including the group of large fish is displayed, the bonus bubble corresponding to the winning mode E is displayed to overlap the specific symbol and the transition to the bonus game is decided. The player can recognize that the display of the fish group including the group of large fish displayed immediately before is confirmation of the transition to the bonus game. The same applies to, for example, the case of the payout bubble.

On the other hand, in the gaming machine 10 that has not won the mode E, after the fish group including the group of large fish is displayed, the payout bubble is displayed to overlap the specific symbol and the granting of the payout is determined. The player can recognize that the display of the fish group including the group of large fish displayed immediately before is the decision of the granting of the payout. The same applies to, for example, the case of the bonus bubble.

Note that, when the granting of the predetermined number or more of payouts is decided or when the transition to the bonus game is determined in a mode other than the mode E, whether to display the fish group including the group of large fish may be determined by lottery.

When determining in step S925 not to display the fish group (NO) and when executing the processing of step S927, the CPU 110 of the controller 100 determines whether to end the precursor display during the execution of the unit game (step S929).

For example, when the transition to the bonus game is decided by the bonus bubble corresponding to the winning mode E, the CPU 110 of the controller 100 ends the precursor display (step S931) and ends this subroutine.

When determining in step S929 not to end the precursor display during the execution of the unit game (NO), the CPU 110 of the controller 100 immediately ends this subroutine.

### <<<Arriving Bubble Treatment>>

FIG. 10 is a flowchart illustrating the fish group display processing.

### <Bubble Moving to the Arrival Display Region 434>

Some of the bubbles moved on the symbol display region 400 are displayed to arrive at the arrival display region 434 after passing the symbol display region 400. The bubbles arriving at the arrival display region 434 are determined by the bubble arrival determination processing of step S531 in FIG. 5. For example, the bubble arrival determination processing determines bubbles with the lottery processing. The lottery processing can be a processing provided with weight according to a type of a bubble, the number of bubbles arriving at the arrival display region 434, and the like.

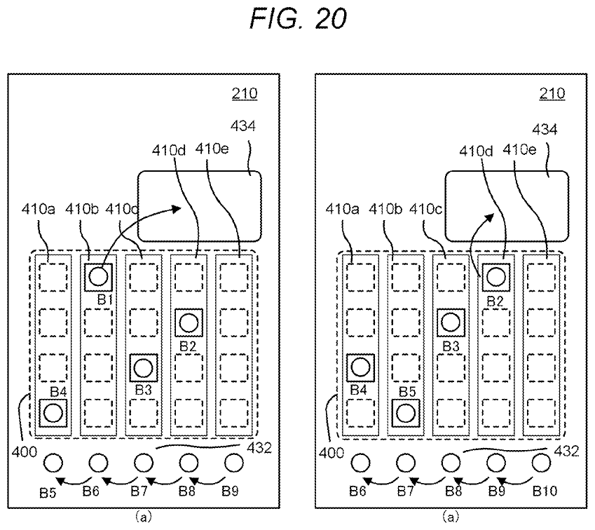

FIG. 20 is a diagram illustrating bubbles arriving at the arrival display region 434. Bubbles likely to arrive at the arrival display region 434 are bubbles located in the first row (the uppermost row). The bubbles determined as arriving at the arrival display region 434 by the lottery processing are displayed to move toward the arrival display region 434. The left diagram of FIG. 20 illustrates a form in which a bubble B1 positioned in the first row of the video reel 410b moves toward the arrival display region 434. The right diagram of FIG. 20 illustrates a form in which a bubble B2 located in the first row of the video reel 410d moves toward the arrival display region 434.

The bubbles determined as not arriving at the arrival display region 434 by the lottery processing are displayed to gradually disappear while moving in the upper direction from the first row.

The arrival display region 434 has a gap (not illustrated) and is displayed in a state in which the gap is narrow or wide. Usually, the arrival display region 434 is displayed in a state in which the gap is narrow. When the bubbles arrive at the arrival display region 434, the bubbles are displayed to be sucked from the narrow gap of the arrival display region 434.

First, the CPU 110 of the controller 100 determines whether an opening condition for opening the gap in the arrival display region 434 is satisfied (step S1011). For example, the opening condition can be, for example, the number of bubbles that have arrived at the arrival display region 434. The number of bubbles may be counted according to a type of the bubbles or a total number of bubbles of all types may be counted. The opening condition may be winning a lottery. At this time, a winning probability may be varied according to the number of bubbles arriving at the arrival display region 434 in the game.

When the opening condition is not satisfied in step S1011 (NO), the CPU 110 of the controller 100 ends this subroutine.

When the opening condition is satisfied in step S1011 (YES), the CPU 110 of the controller 100 performs display for opening the arrival display region 434 (step S1013), performs display for discharging bubbles (step S1015), and executes the special game (step S1017).

The special game described herein is another bonus game different from the free game. For example, the special game can be a roulette game, a skill game, or the like. The special game may be the free game. The special game may be a free game for displaying a symbol different from a symbol of a normal free game or granting a different payout.

Subsequently, the CPU 110 of the controller 100 determines the number of payouts of the special game (step S1019). Through this processing, a payout is calculated by calculating a sum of payouts obtained in the special game.

### <<<Scroll Display Control Processing>>>

FIG. 11 is a flowchart illustrating scroll display control processing. This processing is executed in common in the video slot game of the base game and the free game.

First, the CPU 110 of the controller 100 starts scrolling a video reel in the symbol display region 400 (step S1111). In the processing of step S1111, the CPU 110 of the controller 100 determines a position where scrolling of the video reel 410 is started and starts the scrolling. In the scroll display, scrolling of video reel 410 is started according to an arrangement of symbols defined in a symbol table (not illustrated).

Subsequently, the CPU 110 of the controller 100 determines whether it is timing to stop scrolling of any of the video reels (step S1113).

When determining in the determination processing in step S1113 that it is not the timing to stop the scrolling (NO), the CPU 110 of the controller 100 returns the processing to step S1113.

When determining in the determination processing in step S1113 that it is the timing to stop the scrolling (YES), the CPU 110 of the controller 100 stops the video reel such that the symbol determined by the stop symbol lottery processing in FIG. 8 is displayed in a predetermined stop position (for example, the bottom stage (the fourth row)) of the symbol display region 400 (step S1115).

Subsequently, the CPU 110 of controller 100 determines whether all the video reels are stopped (step S1117).

When determining that not all the video reels are stopped (NO), the CPU 110 of the controller 100 returns the processing to step S1113.

When determining that all the video reels are stopped (YES), the CPU 110 of the controller 100 ends this subroutine.

By this processing, the arrangement of the twenty symbols is temporarily released and thereafter rearranged in the symbol display region 400. By the rearrangement, the twenty symbols are stopped and displayed in a matrix shape of 4 rows and 5 columns.

Note that, when the SPIN button 330 or the like is operated during the scrolling, the processing can be skipped to immediately stop all the video reels and stop-display all stop symbols.

### <<<Movement of Bubbles>>

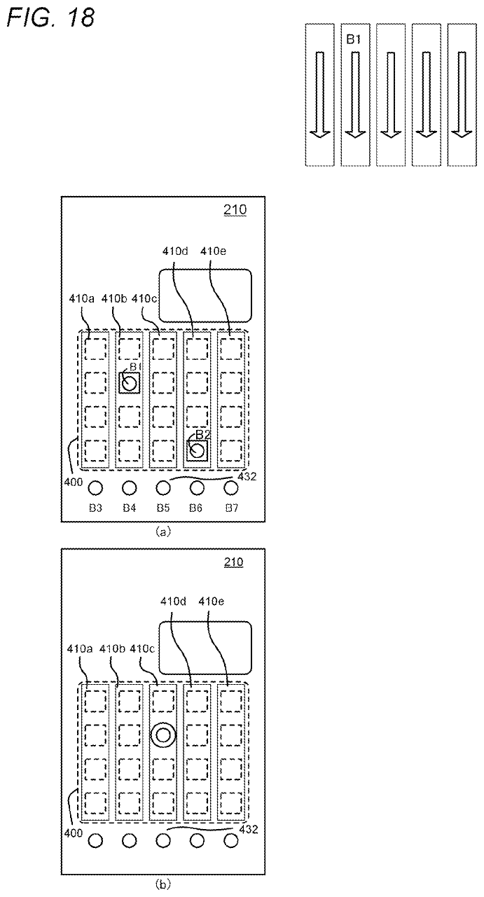

FIG. 17 and FIG. 18 are diagrams illustrating examples of movement of bubbles.
(a) of FIG. 17 is a diagram illustrating a state in which bubbles are displayed only in the pre-display region 432 and no bubble is displayed in the symbol display region 400.

In the pre-display region 432, five bubbles are displayed in the horizontal direction. The bubble B1 is displayed in the leftmost position in the pre-display region 432. The bubble B2 is displayed in a position on the right of the leftmost position. A bubble B3 is displayed in a position on the right of the position. A bubble B4 is displayed in a position on the right of the position. A bubble B5 is displayed in the rightmost position.

When the unit game starts, the bubble B1 in the leftmost position in the pre-display region 432 moves to the symbol display region 400. As explained above, a destination to which the bubble B1 moves is determined by the lottery processing.

Further, the bubbles B2 to B5 displayed in the pre-display region 432 are shifted to the left one and displayed.
(b) of FIG. 17 is a diagram illustrating a state at the time when the unit game starts and the video reels 410a to 410e are scrolled and displayed in symbol display region 400.

As illustrated in (b) of FIG. 17, the scroll display of the video reels 410a to 410e is indicated by white downward arrows. The bubble B1 moves from the pre-display region 432 and is stopped and displayed in the third row of the video reel 410b.

Thereafter, when the video reels 410a to 410e stop and the symbols are rearranged, the bubble B1 and the symbols are stopped and displayed to overlap (see (c) of FIG. 17).

In the pre-display region 432, the bubble B6 read from the symbol display region management table is displayed in the rightmost position. In the pre-display region 432, five bubbles B2, B3, B4, B5, and B6 are displayed.
(c) of FIG. 17 is a diagram illustrating a state in which bubbles are displayed in the symbol display region 400 and the pre-display region 432 at the time when the next unit game starts.

The bubble B2 is displayed in the leftmost position in the pre-display region 432. The bubble B3 is displayed in a position on the right of the leftmost right position. A bubble B4 is displayed in a position on the right of the position. The bubble B5 is displayed in a position on the right of the position. The bubble B6 is displayed in the rightmost position.

When the unit game starts, the bubble B2 in the leftmost position in the pre-display region 432 moves to the symbol display region 400. The bubble B1 already displayed in the symbol display region 400 moves to the second row immediately above the video reel 410b.

Further, the bubbles B3 to B5 displayed in the pre-display region 432 are shifted to the left direction by one and displayed.
(d) of FIG. 17 is a diagram illustrating a state at the time when the unit game starts and the video reels 410a to 410e are scrolled and displayed in the symbol display region 400.

As illustrated in (d) of FIG. 17, the scroll display of the video reels 410a to 410e is indicated by white downward arrows. The bubble B1 is stopped and displayed in the second row of the video reel 410b. The bubble B2 moves from the pre-display region 432 and is stopped and displayed in the fourth row of the video reel 410d.

In the pre-display region 432, the bubble B7 read from the symbol display region management table is displayed in the rightmost position. In the pre-display region 432, five bubbles B3, B4, B5, B6, and B7 are displayed.
(a) of FIG. 18 is a diagram illustrating a state in which the video reels 410a to 410e stop and the symbols are rearranged. When the video reels 410a to 410e stop and the symbols are rearranged, the bubble B1 is stopped and displayed to overlap the symbol (a white squares). The bubble B2 is stopped and displayed to overlap the symbol (a white square) (not illustrated). When the symbols stopped and displayed are specific symbols, a result of the unit game is decided according to types of the bubbles B1 and B2.
(b) of FIG. 18 is a view illustrating a state in which a rearranged specific symbol (a large white circle) and a bubble (a small white circle) overlap. A result of the unit game is determined according to a type of the bubble. In the case of the payout bubble, a payout associated with the payout bubble is granted. In the case of the bonus bubble, transition to the bonus game is determined and the game transitions to the bonus game from the next unit game.

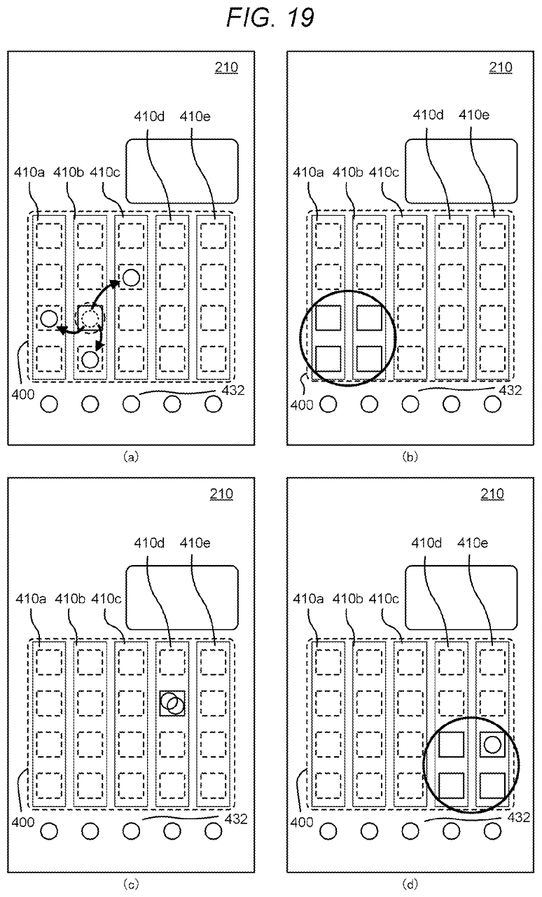

FIG. 19 is a diagram illustrating forms of bubbles displayed in the symbol display region 400 according to types of the bubbles.
(a) of FIG. 19 is a diagram illustrating a form at the time when a type of a bubble is the payout bubble. When the type of the bubble is the payout bubble, when the specific symbol and the payout bubble are stopped and displayed to overlap, the payout bubble is displayed to be split into at least one or more bubbles. In (a) of FIG. 19, an original payout bubble before the split is indicated by a broken line, three next generation payout bubbles split (derived) from the original payout bubble are indicated by white circles, and correspondence from the original payout bubble to the next generation payout bubbles is indicated by arrows. The number of split payout bubbles is determined by the lottery processing. By increasing the number of payout bubbles by the splitting, it is possible to increase possibility of further increasing a payout from the next unit game.
(b) of FIG. 19 is a diagram illustrating a form at the time when a type of a bubble is the large bubble. When the type of the bubble is the large bubble, the bubble is displayed to overlap symbols stopped and displayed in a plurality of stop positions. When specific symbols are included in a bubble overlapping the large bubble, a prize of the large bubble is granted according to the number of all the included specific symbols. When the large bubble is the payout bubble, a value obtained by multiplying the number of all the specific symbols included in the large bubble by a payout corresponding to the large bubble is determined as a payout. When the large bubble and the specific symbols overlap, the bubble is also split. The large bubble does not split and increase and a small normal bubble splits and increases.
In (c) of FIG. 19, when a plurality of payout bubbles are stopped and displayed in the same stop position, the plurality of payout bubbles are integrated and displayed as a single bubble. When the plurality of payout bubbles are integrated, a sum of payouts of the integrated plurality of payout bubbles is paid out as a payout. Note that, in (c) of FIG. 19, for clarity, a state immediately before two bubbles are integrated into one bubble is illustrated.
(d) of FIG. 19 is a diagram illustrating a form at the time when a large bubble and a normal bubble smaller than the large bubble overlap. When the large bubble and the normal bubble overlap, the large bubble and the normal bubble are displayed in an overlapping state without being integrated. A sum of payouts of the large bubble payout and the normal bubble overlapping is paid out as a payout.

### <<<Display of Bubbles in the Free Game>>>

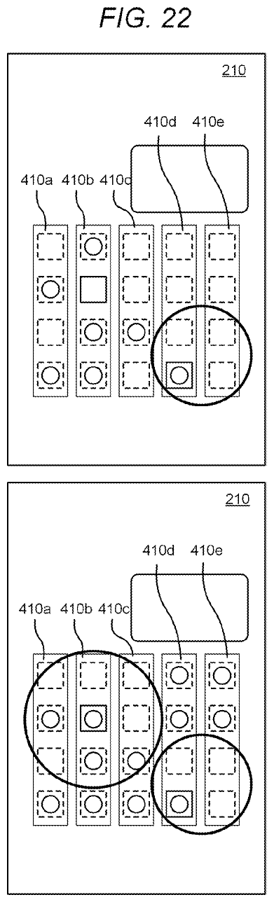

FIG. 22 is a diagram illustrating a form of bubbles displayed in the free game. As explained above, in the base game, every time the unit game starts, a bubble moves up by one. When the unit game starts, a bubble located in the uppermost first row moves away from the symbol display region 400 and disappears or arrives at the arrival display region 434.

In the free game, a bubble is not displayed in the pre-display region 432 but is displayed only in the symbol display region 400. At the start of the free game (a first unit game of the free game), a predetermined number of bubbles are displayed at the stop positions in the symbol display region 400. The predetermined number may be a predetermined constant number or a number determined by the lottery processing or the like.

In the free game, the bubbles displayed in the symbol display region 400 continuously remain the stop positions without moving and are displayed until the free game ends. In the free game, bubbles split every time the unit game ends. The number of splitting bubbles and the stop positions are determined by the lottery processing. When a split bubble moves to a stop position where a bubble is not yet stopped and displayed, the split bubble is displayed as it is. When the split bubble moves to a stop position where a bubble is already stopped and displayed, the stopped bubble and the split bubble are integrated and displayed. A payout of the stopped bubble and a payout of the split bubble are added up and displayed in the integrated bubble. In this way, as the unit game progresses, bubbles are displayed to proliferate.
(a) of FIG. 22 is a diagram illustrating a state in which the symbol display region 400 is not yet occupied by bubbles. (b) of FIG. 22 is a diagram illustrating a state in which the unit game further progresses and all the stop positions in the symbol display region 400 are occupied by bubbles. As illustrated in (b) of FIG. 22, depending on the progress of the free game, all the stop positions are sometimes occupied by bubbles. As explained above, in the free game, the number of bubbles stopped and displayed in the stop positions in the symbol display region 400 can be increased and, as the unit game progresses, possibility of the bubbles being stopped and displayed to overlap the specific symbol can be gradually increased.

### REFERENCE SIGNS LIST

10 gaming machine
100 controller
210 main display
220 lower display

1. A gaming machine comprising:
a display including a scroll area where a video reel including a plurality of main symbols is scrolled, the main symbols are rearranged after the scrolling, and a game result of a unit game is displayed and a non-scroll area where the video reel is not scrolled, a sub-symbol different from the main symbols being displayed in the non-scroll area and moving from the non-scroll area to the scroll area;
a memory that stores information concerning the main symbols and information concerning the sub-symbol; and
a controller that controls display of the main symbols and the sub-symbol on the display, the controller determining display content of the sub-symbol based on at least one probability mode among a plurality of probability modes respectively associated with probabilities different from one another.

2. The gaming machine according to claim 1, wherein
the controller is capable of executing a base game and a bonus game different from the base game,
prizes include provision of a payout and provision of the bonus game, and
the memory includes:
a first table for lottery that determines a first sub-symbol indicating that the payout can be provided; and
a second table for lottery that determines a second sub-symbol indicating that the bonus game can be provided, the second table for lottery being selected at a probability higher than a probability that the first table for lottery is selected, and
prize selection processing selects the one prize referring to the first table for lottery and the second table for lottery.

3. The gaming machine according to claim 1, wherein one or more unit games are associated as a single set, and one probability mode included in the series of probability modes is used for one set.

4. The gaming machine of claim 3, wherein the series of probability modes are determined in advance for each of a plurality of sets.

5. The gaming machine according to claim 4, wherein, when a specific probability mode is included in the series of probability modes, the controller displays, on the display, information indicating that the specific probability mode is included.

6. The gaming machine according to claim 5, wherein, when the controller is capable of communicating with other gaming machines via a network and the specific probability mode is included in the plurality of sets, the controller transmits information indicating that the gaming machine has the specific probability mode to the other gaming machines.

7. The gaming machine of claim 6, wherein,
when a specific prize is selected and the player maintains a same bet and continues a game, the controller makes it possible to provide the specific prize after information indicating that the specific probability mode is included is displayed on the display, and
when the specific prize is selected and the player ends the game or changes the bet and advances the game, the controller does not provide the specific prize after the information indicating that the specific probability mode is included is displayed on the display.
